(19) United States
(12) Patent Application Publication
(10) Pub. No.: US 2002/0038424 A1
(43) Pub. Date: Mar. 28, 2002

(54) Apparatus and method for providing security for electronic signatures

(76) Inventors: Raymond Anthony Joao, Yonkers, NY (US); Robert Richard Bock, Yonkers, NY (US)

Correspondence Address: RAYMOND A. JOAO, ESQ., 122 BELLEVUE PLACE, YONKERS, NY, 10703, US

(21) Appl. No.: 09/954,229

(22) Filed: Sep. 17, 2001

Related U.S. Application Data
(60) Provisional application No. 60/234,569, filed on Sep. 22, 2000.

(51) Int. Cl. H04L 9/00

(52) U.S. Cl. 713/176; 705/75

(57) ABSTRACT

An apparatus and method for providing security for electronic signatures, including a processor, for processing information corresponding to at least one of a transaction, an agreement, and a contract, involving at least one of an electronic signature, an electronic initial, an electronic identification code, electronic identification information, and electronic identification indicia, and further wherein the processor at least one of generates and transmits a transaction report, wherein the transaction report contains information for providing a notification of a use of the at least one of an electronic signature, an electronic initial, an electronic identification code, electronic identification information, and electronic identification indicia, and a transmitter, for transmitting the transaction report to at least one of at least one of an individual and an entity associated with the at least one of an electronic signature, an electronic initial, an electronic identification code, electronic identification information, and electronic identification indicia, and to a communication device associated with the at least one of an individual and an entity associated with the at least one of an electronic signature, an electronic initial, an electronic identification code, electronic identification information, and electronic identification indicia. The transaction report provides notification of the use of the at least one of an electronic signature, an electronic initial, an electronic identification code, electronic identification information, and electronic identification indicia.

### RELATED APPLICATIONS

This application claims the benefit of priority of U.S. Provisional Patent Application Ser. No. 60/234,569, filed Sep. 22, 2000, and entitled “APPARATUS AND METHOD FOR PROVIDING SECURITY FOR ELECTRONIC SIGNATURES”, the subject matter of which is hereby incorporated by reference herein.

### FIELD OF THE INVENTION

The present invention pertains to an apparatus and a method for providing security for electronic signatures and, in particular, to an apparatus and method for providing security for electronic signatures which can be utilized in order to provide notification to individuals and/or entities of the use or usage of their respective electronic signatures and/or other electronic identification codes and/or indicia and/or which can be utilized to provide control over the use or usage of electronic signatures and/or other electronic identification codes and/or indicia.

### BACKGROUND OF THE INVENTION

The tremendous growth of the Internet and/or the World Wide Web, as well as the tremendous growth in the number of users of the Internet and/or the World Wide Web, has no doubt established the Internet and/or the World Wide Web as a platform for conducting a variety of transactions, commercial and/or otherwise. The structure of the Internet and/or the World Wide Web, however, is such that privacy and/or security relating to transactions may not always be assured.

Transactions on, or over, the Internet and/or the World Wide Web involve the transmission of data and/or information between the respective parties to a transaction. This information can include social security numbers, credit card numbers, charge card numbers, debit card numbers, financial account information, and/or any other personal and/or financial information. There is no doubt that information transmitted on or over the Internet and/or the World Wide Web can be intercepted, misappropriated, and/or otherwise utilized by unscrupulous, devious, and/or dishonest individuals and/or entities, in order to perpetrate fraudulent acts involving the personal and/or financial accounts and/or the obligations of unsuspecting and/or unknowing individuals or entities. This reality can prove to be disastrous to individuals or entities who are victimized by these fraudulent practices.

The emergence of electronic signatures and/or digital signatures as a recognized medium by which individuals or entities may enter into, and/or become legally bound by, transactions, agreements, and/or contracts, in dealings on, or over, the Internet and/or the World Wide Web introduces yet another potential security problem for individuals and/or entities entering into transactions, agreements, and/or contracts, on, or over, the Internet and/or the World Wide Web.

The possibility that electronic signatures and/or digital signatures can be intercepted and/or misappropriated, in manners similar to and/or analogous to, the manners in which personal and/or financial information can be intercepted, misappropriated and/or utilized in fraudulent transactions, has raised serious security concerns.

As a result, there is a great need for innovations which can provide security for electronic signatures, digital signatures, and/or other electronic identification information, as the Internet and/or the World Wide Web, and the use of same as a platform for conducting transactions, continues to grow and develop.

### SUMMARY OF THE INVENTION

The present invention pertains to an apparatus and method for providing security for electronic signatures which overcomes the shortcomings of the prior art. The present invention pertains to an apparatus and a method for providing security for electronic signatures and, in particular, to an apparatus and methods for providing security for electronic signatures which can be utilized in order to provide notification to individuals and/or entities of the usage of their respective electronic signatures and/or other electronic identification codes and/or indicia and/or which can be utilized to provide control over usage of electronic signatures and/or other electronic identification codes and/or indicia.

The present invention provides an apparatus and method for providing notification to individuals and/or entities of a use or usage of their respective electronic signatures and/or other electronic codes and/or indicia. The present invention can be utilized to provide notification and/or to inform an individual and/or entity of a use or usage of his, her, or its, electronic signature or other electronic information code and/or indicia, in a transaction, to form an agreement, to bind the individual and/or entity to an obligation, and/or to otherwise commit the individual and/or entity to a legal, non-legal, financial, non-financial, and/or any other obligation.

The present invention can also be utilized in order to allow an individual and/or entity to provide control over the usage of his, her, or its, set restrictions, limitations, and/or other parameters, regarding use or usage of his, her, or its, electronic signatures and/or other electronic codes and/or indicia. The apparatus and method of the present invention can also be utilized to allow an individual and/or entity to pre-restrict and/or pre-limit use or usage of his, her, or its, electronic signatures and/or other electronic codes and/or indicia.

The present invention can also be utilized in order to provide a multitude of other security, notification, and/or control, services and/or processing routines in order to provide security for, or related to, electronic signatures and/or other electronic identification codes and/or other indicia.

The electronic signatures, digital signatures, electronic initials, digital initials, electronic identification codes, digital identification codes, electronic identification indicia and/or digital identification indicia, can be utilized in any transaction, contract, agreement, and/or other relationship creation activity, for or involving a transaction of any kind, a commercial transaction, a non-commercial transaction, a financial transaction, a transaction on a financial and/or a brokerage account, a non-financial transaction, a transaction involving the buying, selling, trading, bartering, giving, and/or gifting, of any goods, products, and/or services, which can be the subject of commerce and/or otherwise, non-financial transactions, contractual agreements, contractual relationships, and/or any other agreement, relationship, and/or activity, which can create a liability, liabilities, an obligation, and/or obligations, of any kind or type, financial and/or non-financial, and/or any other type.

The apparatus can include a central processing computer or server computer. The central processing computer can provide control over the apparatus and can perform various processing operations for providing any of the various processing routines and/or services described herein. The central processing computer can also provide various services and/or functionality for or regarding any of the individuals and/or entities who or which utilize the apparatus and method of the present invention. Any number of central processing computers can be utilized in the apparatus of the present invention.

The apparatus can also include one or more user computers or user communication devices with each user computer being associated with an user, individual, entity, or group of users, individuals, or entities. Any user computer may also be associated with a number of users, individuals, and/or entities, depending upon the application. Any number of user computers can be utilized in the apparatus of the present invention.

The apparatus can also include one or more counter party computers or counter party communication devices with each counter party computer being associated with a counter party, a provider, a goods provider, a products provider, a services provider, a transaction party, a transaction counter party, a merchants, vendors, a buyer, a seller, and/or an agent of other third party who or which acts for, or on behalf of, any of the above-described counter parties, providers, goods providers, products providers, services providers, transaction parties, transaction counter parties, merchant, vendors, buyers, sellers, agents, and/or third parties. Any number of counter party computer can be utilized in the apparatus of the present invention.

The central processing computer(s), the user computers, and/or the counter party computers, can communicate with each other via any suitable communication network or system. Each of the central processing computer(s), the user computers, and/or the counter party computers, can communicate and/or interact with any central processing computer(s), the user computers, and/or the counter party computers.

The apparatus can be utilized on, over, or in conjunction with, the Internet and/or the World Wide Web. The apparatus can also be utilized on, over, or in conjunction with, any appropriate communication networks or systems including, but not limited to, network communication systems, telephone communication networks or systems, wired or line connected communication networks or systems, wireless communications networks or systems, cellular communication networks or systems, digital communication networks or systems, personal communication networks or systems, personal communication services (PCS) networks or systems, satellite communication networks or systems, broad band communication networks or systems, bluetooth communications networks or systems, low earth orbiting (LEO) satellite networks or systems, and/or public switched telephone networks or systems.

The apparatus and method of the present invention can be utilized on, over, and/or in conjunction with, a wireless communication network or system, a wired or line-connected communication network or system, or any combination of a wireless communication network or system and a wired or line-connected communication network or system.

The present invention can also utilize wireless Internet and/or World Wide Web services, equipment and/or devices. Any of the central processing computer(s), the user computers, and/or the counter party computers, can have a web site or web sites associated therewith.

Any of the computer to computer communications, and/or any of the communications which can occur between any of the herein-described individuals and/or entities and/or their respective computers, can be made and/or can be effected by an e-mail transmission, an e-mail message, an electronic transmission, a telephone message, a letter mail delivery, a telephone transmission, a facsimile transmission, a beeper or a pager message, and/or via any other notification means or method. Any and/or all of the communications which can occur between any of the herein-described computers and/or the individuals and/or entities associated therewith can also contain text information, video information, audio information, audio/video information, and/or any combination of same.

The central processing computer(s), the user computers, and/or the counter party computers can have databases or memory storage devices for storing any of the data and/or information which may be needed and/or which may be desired for performing any of the processing routines and/or processing functionality described herein as being performed by the apparatus and method of the present invention.

The apparatus and method of the present invention can be utilized in order to provide notification to an individual and/or an entity of a use or usage of his, her, or its, electronic signature(s), electronic initials, and/or other electronic identification code(s) and/or other indicia. The apparatus can also be utilized to provide notification to an individual and/or an entity when an electronic signature associated with the individual or entity is utilized in a transaction.

The apparatus can also be utilized in order to provide notification to an individual or entity when an electronic initial, electronic identification information, and/or other electronic indicia associated with and/or belonging to the individual or entity is utilized and/or is being utilized for the purpose of entering into a transaction, an agreement, a contract, and/or any other relationship which may result in and/or involve the creation of a liability or liabilities and/or an obligation and/or obligations of any type for the individual or entity.

The apparatus can also receive, process and store, information regarding restrictions and/or limitations on the use or usage of an individuals or an entity's electronic signatures), electronic initial(s), electronic identification code(s), or electronic identification indicia, and process transactions in accordance with the restrictions and/or limitations.

The apparatus of the present invention can also process an electronic signature and/or electronic signature information, identify the individual or entity associated with the electronic signature and/or electronic signature information and provide notification to the individual or entity of the use or usage of the electronic signature and/or electronic signature information. The apparatus can also provide the individual or entity with information concerning the transaction, agreement, and/or contract, in which the electronic signature is being used or has been used.

The apparatus can also receive and process responses form the individual or entity concerning whether a uses or usage of the electronic signature is approved, authorized, disapproves, or unauthorized. The apparatus can then utilize the information contained in the individual's or the entity's response to either complete the transaction or to cancel the transaction.

The apparatus information regarding any of the transactions, agreements, and/or contracts, in which the electronic signatures are utilized as well as information regarding-any of the uses or attempted uses of the electronic signature, electronic initials, electronic identification code(s), electronic identification information, electronic identification information, and/or electronic identification indicia, described herein.

The apparatus and method of the present invention can also be utilized in order to allow an individual and/or entity to pre-restrict and/or to pre-limit, and/or to otherwise set or establish parameters for use or usage of his, her, or its, electronic signature(s), electronic initials, electronic identification code(s), and/or other electronic identification indicia.

The information regarding the restrictions and/or limitations can be provided by the individual or entity in real-time and/or otherwise. The central processing computer can process and store the information regarding the restrictions and/or limitations.

The information regarding the restrictions and/or limitations can be changed at any time by the individual or entity. The information regarding the restrictions and/or limitations can also be added to and/or supplemented at any time by the individual or entity.

Once a transaction, an agreement, or a contract, involving any one of the electronic signature (s), electronic initial(s), electronic identification code(s), electronic identification information, electronic identification information, and/or electronic identification indicia, is detected, the central processing computer can process information regarding the transaction, the agreement, or the contract, in conjunction with information regarding any of the restrictions and/or limitations.

The central processing computer can ascertain and/or determine whether the transaction, agreement, or contract, is authorized or not authorized pursuant to the restrictions and/or limitations which are associated with the use or usage of the respective electronic signature(s), electronic initial(s), electronic identification code(s), electronic identification information, electronic identification information, and/or electronic identification indicia.

The central processing computer can then either complete the transaction or cancel the transaction depending upon whether the transaction, agreement, or contract, is authorized or unauthorized, respectively.

The individual or entity can also access the central processing computer and provide information to the apparatus or the central processing computer, which information can be utilized for, and/or to facilitate, a pre-authorization for, or a pre-approval of, the use of any one or more of his, her, or its, electronic signature(s) and/or electronic signature information. The apparatus or the central processing computer can store the pre-authorization information and/or the pre-approval information. The apparatus or the central processing computer can process a transaction, an agreement, or a contract, in which the electronic signature is being utilized, in accordance with, and/or in conjunction with, the individual's or the entity's instructions regarding the pre-authorization and/or the pre-approval, in order to effectuate the consummation or completion of the respective transaction, agreement, and/or contract, in accordance with the desires of the individual or entity.

The apparatus or the central processing computer can store any and/or all of the information regarding the transaction, the agreement, or the contract, and update any records or files for or regarding the individual or the entity, and/or update and records for or regarding any of the respective electronic signature(s), electronic initial(s), electronic identification code(s), electronic identification information, electronic identification information, and/or electronic identification indicia.

The central processing computer, prior to completing or consummating the transaction, the agreement, or the contract, can generate a transaction report containing any pertinent information regarding the transaction, the agreement, the contract, the subject matter of the respective transaction, agreement, or contract, the parties, counter party, or counter parties, involved in the respective transaction, agreement, or contract, and/or the respective electronic signature(s), electronic initial(s), electronic identification code(s), electronic identification information, electronic identification information, and/or electronic identification indicia, utilized in the transaction, agreement, or contract.

The transaction report can be transmitted to the user computer or user communication device associated with the individual or entity for review by the individual or entity. The individual or entity can then decide whether to approve the transaction, the agreement, or the contract, or to disapprove of the transaction, the agreement, or the contract. The individual or entity can transmit a response to the central processing computer which can process same and either complete or cancel the transaction, agreement, or contract, as directed.

The central processing computer, prior to, during, or subsequent to canceling the transaction, the agreement, or the contract, can generate a transaction report containing any pertinent information regarding the transaction, the agreement, the contract, the subject matter of the respective transaction, agreement, or contract, the parties, counter party, or counter parties, involved in the respective transaction, agreement, or contract, and/or the respective electronic signature(s), electronic initial(s), electronic identification code(s), electronic identification information, electronic identification information, and/or electronic identification indicia, utilized in the transaction, agreement, or contract.

The transaction report can be transmitted to the user computer or user communication device associated with the individual or entity. The individual or entity can review the information contained in the transaction report and transmit an appropriate response, if desired, to the central processing computer. The response can contain other or additional restrictions and/or limitations regarding the respective electronic signature(s), electronic initial(s), electronic identification code(s), and/or other electronic identification indicia.

If the response contains other or additional restrictions and/or limitations regarding the respective electronic signature(s), electronic initial(s), electronic identification code(s), and/or other electronic identification indicia, then the central processing computer can process and store the information regarding the restrictions and/or limitations for processing in a subsequent transaction(s) involving the respective electronic signature(s), electronic initial(s), electronic identification code(s), and/or other electronic identification indicia.

The apparatus and method of the present invention can be utilized in order to provide a multitude of services and/or processing routines for providing information and/or for processing information for providing security for any of the electronic signatures, the electronic initials, the electronic identification code(s), and/or any other electronic identification indicia, described herein.

The apparatus and method of the present invention can be utilized in order to maintain records of use or usage of any of the herein-described electronic signatures, electronic initials, electronic identification codes, electronic identification information, electronic identification information, and/or electronic identification indicia.

The apparatus and method of the present invention and, in particular, each of the central processing computers, the user computers, and/or the counter party computers, can record and store information regarding any and/or all use or usage of any of the electronic signatures, electronic initials, electronic identification codes, electronic identification information, and/or electronic identification indicia, which are used or utilized in conjunction with a transactions, agreements, and/or contracts. Information and/or details for, or regarding, any of the transaction, agreements, or contracts, can also be recorded and stored along with information regarding the respective electronic signatures, electronic initials, electronic identification codes, electronic identification information, and/or electronic identification indicia, which are utilized in conjunction therewith.

Transaction numbers or transaction identification numbers can be assigned to each of the transactions, agreements, and contracts, with the transaction numbers or transaction identification number associated with and/or corresponding to the particular use or instance of use of each of the respective electronic signatures, electronic initials, electronic identification codes, electronic identification information, and/or electronic identification indicia.

The central processing computer can process the usage and/or transaction information and can generate transaction statements regarding the use or usage of the respective electronic signatures, electronic initials, electronic identification codes, electronic identification information, and/or electronic identification indicia. The transaction reports can be generated periodically and/or at any time.

An individual or entity can also access the central processing computer and request a transaction report. The central processing computer can process the individual's request for the transaction report, generate the transaction report and transmit same to the user computer or the user communication device in real-time and/or at any other time.

The apparatus and/or the central processing computer can also count the number of times a respective electronic signature(s), electronic initial(s), electronic identification code(s), electronic identification information, and/or electronic identification indicia, have been used in authorized transactions and can store and/or maintain this information. The apparatus and/or central processing computer can also count the number of times in which the respective electronic signature(s), electronic initial(s), electronic identification code(s), electronic identification information, and/or electronic identification indicia, have been attempted to be used in unauthorized transactions and can store and/or maintain this information.

The apparatus and/or central processing computer can also record and/or store any information regarding the use, attempted use, authorized use, approved use, unauthorized use, and/or unapproved use, of any of the respective electronic signature(s), electronic initial(s), electronic identification code(s), electronic identification information, and/or electronic identification indicia, and store and/or maintain records and/or information regarding same.

The apparatus and/or the central processing computer can also cancel and/or de-activate the use or usage of an electronic signatures), electronic initial(s), electronic identification code(s), electronic identification information, and/or electronic identification indicia, upon determining that it has been used, that it is being used, and/or that it has attempted to be used, in an unauthorized manner.

The apparatus can also provide information regarding the origination or originating addresses, of the respective computers or communication devices, regarding each of the respective electronic signatures(5, electronic initial(s), electronic identification code(s), electronic identification information, and/or electronic identification indicia, which are utilized in a transaction, agreement, or contract.

Intelligent agents, software agents, mobile agents, and/or related technologies, can be utilized in conjunction with the present invention. The respective “intelligent agent(s), software agent(s), and/or mobile agent(s) can be programmed and/or designed to act on behalf of any of the respective the user(s), individual(s), entity, entities, party, parties, counter party, and/or counter parties, described herein, so as to act on behalf of the respective party as well as to perform any of processing functions and/or other functions described herein.

The present invention also provides an agent-based apparatus and method for providing security for electronic signatures.

The apparatus of the present invention, in any and/or all of the embodiments described herein, can also be programmed to be self-activating and/or activated automatically.

The apparatus of the present invention can also be programmed in order to automatically generate and/or transmit any of the e-mail messages, electronic message transmissions, electronic notification transmissions, telephone calls, telephone messages, facsimile transmissions, and/or communications of any kind, which are described herein, between any of the parties which utilize the present invention.

Any electronic messages, such as e-mails, electronic message transmissions, pager messages, telephone calls or messages, facsimile transmissions, etc., which are generated by the central processing computer, and/or any of the other computers can contain appropriate links, hyperlinks, and/or forwarding information, to the sending party to another electronic message and/or e-mail, to a third party, to other information, and/or to another information source.

The present invention, in any and/or all of the herein-described embodiments, can utilize electronic commerce technologies and security methods, techniques and technologies.

The apparatus of the present invention can also be utilized in order to monitor and/or record information regarding any and/or all of the interactions, negotiations, and/or deals reached, between any of the individuals, entities, parties, ands/or counter parties, described herein.

Accordingly, it is an object of the present invention to provide an apparatus and method for providing security for electronic signatures.

It is another object of the present invention to provide an apparatus and method for providing security for electronic signatures, electronic initials, electronic identification information, electronic identification codes, or electronic identification indicia.

It is still another object of the present invention to provide an apparatus and method for providing security for electronic signatures which can be utilized in order to provide notification to individuals and/or entities of the use or the usage of his, her, or its, respective electronic signature(s).

It is yet another object of the present invention to provide an apparatus and method for providing security for electronic signatures which can be utilized in order to provide notification to individuals and/or entities of the usage of their respective electronic signatures, electronic initials, electronic identification information, electronic identification codes, or electronic identification indicia.

It is another object of the present invention to provide an apparatus and method for providing security for electronic signatures which can be utilized to provide control over the use or usage of electronic signatures.

It is another object of the present invention to provide an apparatus and method for providing security for electronic signatures which can be utilized to provide control over the use or usage of electronic signatures, electronic initials, electronic identification information, electronic identification codes, or electronic identification indicia.

It is still another object of the present invention to provide an apparatus and method for providing security for electronic signatures which can be utilized in order to provide notification and/or to inform an individual and/or entity of a use or usage of his, her, or its, electronic signature in a transaction, to form an agreement, to bind the individual and/or entity to an obligation.

It is yet another object of the present invention to provide an apparatus and method for providing security for electronic signatures which can be utilized in order to provide notification and/or to inform an individual and/or entity of a use or usage of his, her, or its, electronic signature, electronic initials, electronic identification information, electronic identification codes, or electronic identification indicia, in a transaction, to form an agreement, and/or to bind the individual and/or entity to an obligation.

It is another object of the present invention to provide an apparatus and method for providing security for electronic signatures which can allow an individual or entity to exercise or maintain control over the usage of his, her, or its, electronic signature(s).

It is still another object of the present invention to provide an apparatus and method for providing security for electronic signatures which can allow an individual or entity to exercise or maintain control over the usage of his, her, or its, electronic signature(s), electronic initials, electronic identification code(s), or electronic identification indicia.

It is yet another object of the present invention to provide an apparatus and method for providing security for electronic signatures which can allow an individual or entity to set restrictions, limitations, and/or other parameters, regarding the use or usage of his, her, or its, electronic signatures.

It is another object of the present invention to provide an apparatus and method for providing security for electronic signatures which can allow an individual or entity to set restrictions, limitations, and/or other parameters, regarding the use or usage of his, her, or its, electronic signatures, electronic initials, electronic identification code(s), or electronic identification indicia.

It is still another object of the present invention to provide an apparatus and method for providing security for electronic signatures which can be utilized in order to allow an individual and/or an entity to pre-restrict and/or pre-limit use or usage of his, her, or its, electronic signature(s).

It is yet another object of the present invention to provide an apparatus and method for providing security for electronic signatures which can be utilized in order to allow an individual and/or an entity to pre-restrict and/or pre-limit use or usage of his, her, or its, electronic signature(s), electronic initials, electronic identification code(s), or electronic identification indicia.

It is another object of the present invention to provide an apparatus and method for providing security for electronic signatures, which can be utilized to process information regarding, and/or in conjunction with, any type or kind of transaction, agreement, or contract.

It is still another object of the present invention to provide an apparatus and method for providing security for electronic signatures which can be utilized on, over, and/or in conjunction with any communication network.

It is yet another object of the present invention to provide an apparatus and method for providing security for electronic signatures which can be utilized on, over, and/or in conjunction with a wireless communication network.

It is another object of the present invention to provide an apparatus and method for providing security for electronic signatures which can be utilized on, over, and/or in conjunction with the Internet and/or the World Wide Web.

It is still another object of the present invention to provide an apparatus and method for providing security for electronic signatures which can be utilized on, over, and/or in conjunction with a wireless Internet and/or the World Wide Web communication network or system.

It is yet another object of the present invention to provide an apparatus and method for providing security for electronic signatures which can generate and/or transmit messages and/or message transmissions which can include any one or more or text information, video information, audio information, and/or any combination of text, video, or audio, information.

It is another object of the present invention to provide an apparatus and method for providing security for electronic signatures which can provide notification to an individual and/or an entity when an electronic signature(s) associated with the individual or entity is utilized in a transaction.

It is still another object of the present invention to provide an apparatus and method for providing security for electronic signatures which can process information and/or transaction information in conjunction with a use restriction, a use limitation, a pre-authorization, or a pre-approval, regarding a use of an electronic signature(s).

It is yet another object of the present invention to provide an apparatus and method for providing security for electronic signatures which can identify an electronic signature which is involved in a transaction.

It is yet another object of the present invention to provide an apparatus and method for providing security for electronic signatures which can identify an individual or entity associated with an electronic signature which is involved in a transaction.

It is another object of the present invention to provide an apparatus and method for providing security for electronic signatures which can process information received from an individual or entity regarding whether a use of his, her, or its, electronic signature(s) is authorized, approved, unauthorized, or disapproved.

It is still another object of the present invention to provide an apparatus and method for providing security for electronic signatures which can provide information to an individual or entity regarding a use or an attempted use of his, her, or its, electronic signature(s).

It is yet another object of the present invention to provide an apparatus and method for providing security for electronic signatures which can provide for a pre-authorization or a pre-approval of a use or usage of an electronic signature(s).

It is another object of the present invention to provide an apparatus and method for providing security for electronic signatures which can either complete or cancel a transaction in accordance with instructions obtained from an individual or entity associated with an electronic signature(s).

It is still another object of the present invention to provide an apparatus and method for providing security for electronic signatures which can receive information regarding instructions, restrictions, limitations, pre-authorizations, or pre-approvals, for electronic signature(s) use real-time and/or otherwise.

It is yet another object of the present invention to provide an apparatus and method for providing security for electronic signatures wherein information regarding instructions, restrictions, limitations, pre-authorizations, or pre-approvals, for electronic signature(s) use can be changed, modified, or supplemented, at any time.

It is another object of the present invention to provide an apparatus and method for providing security for electronic signatures which can receive information regarding instructions, restrictions, limitations, pre-authorizations, or pre-approvals, for electronic signature(s) use real-time and/or otherwise.

It is still another object of the present invention to provide an apparatus and method for providing security for electronic signatures which can determine whether a transaction, an agreement, or a contract, is authorized or unauthorized in accordance with restrictions, limitations, pre-authorizations, or pre-approvals, which are associated with a use or a usage of an electronic signature(s).

It is yet another object of the present invention to provide an apparatus and method for providing security for electronic signatures which can store and maintain information regarding the use or usage of electronic signature(s) in transactions, agreements, or contracts.

It is another object of the present invention to provide an apparatus and method for providing security for electronic signatures which can update information regarding the use or usage of electronic signature(s) in transactions, agreements, or contracts.

It is still another object of the present invention to provide an apparatus and method for providing security for electronic signatures which can generate a transaction report containing information regarding a transaction, an agreement, or a contract, in which an electronic signature(s) is, has been, or is being, utilized.

It is yet another object of the present invention to provide an apparatus and method for providing security for electronic signatures which can transmit a transaction report, containing information regarding a transaction, an agreement, or a contract, in which an electronic signature(s) is, has been, or is being, utilized, to an individual or entity associated with the electronic signatures).

It is another object of the present invention to provide an apparatus and method for providing security for electronic signatures which can generate a transaction report containing information regarding a transaction, an agreement, or a contract, in which an electronic signature(s) is, has been, or is being, utilized, prior to completing or canceling a transaction, an agreement, or a contract.

It is yet another object of the present invention to provide an apparatus and method for providing security for electronic signatures which can transmit a transaction report, containing information regarding a transaction, an agreement, or a contract, in which an electronic signature(s) is, has been, or is being, utilized, to an individual or entity associated with the electronic signature(s), prior to completing or canceling a transaction, an agreement, or a contract.

It is another object of the present invention to provide an apparatus and method for providing security for electronic signatures can be utilized in order to maintain records of use or usage of any of the herein-described electronic signatures, electronic initials, electronic identification codes, or electronic identification indicia.

It is still another object of the present invention to provide an apparatus and method for providing security for electronic signatures which can record or store information regarding the use or the usage of electronic signatures, electronic initials, electronic identification codes, or electronic identification indicia, which are used or utilized in conjunction with a transaction, an agreement, or a contract.

It is yet another object of the present invention to provide an apparatus and method for providing security for electronic signatures which can record or store information for, or regarding, any of the transactions, agreements, contracts, which involve the use of electronic signatures, electronic initials, electronic identification codes, or electronic identification indicia.

It is another object of the present invention to provide an apparatus and method for providing security for electronic signatures which can assign a transaction number(s) or transaction identification number(s) to transactions involving an electronic signatures(s).

It is still another object of the present invention to provide an apparatus and method for providing security for electronic signatures which can generate transaction statements regarding the use or usage of the respective electronic signatures, electronic initials, electronic identification codes, or electronic identification indicia.

It is yet another object of the present invention to provide an apparatus and method for providing security for electronic signatures which can transmit transaction statements, regarding the use or usage of the respective electronic signatures, electronic initials, electronic identification codes, or electronic identification indicia, to individuals or entities associated with the respective electronic signatures, electronic initials, electronic identification codes, or electronic identification indicia.

It is another object of the present invention to provide an apparatus and method for providing security for electronic signatures which can generate or transmit transaction statements regarding the use or usage of the respective electronic signatures, electronic initials, electronic identification codes, or electronic identification indicia, periodically and/or at any time.

It is still another object of the present invention to provide an apparatus and method for providing security for electronic signatures which can generate or transmit transaction statements regarding the use or usage of the respective electronic signatures, electronic initials, electronic identification codes, or electronic identification indicia, upon request.

It is yet another object of the present invention to provide an apparatus and method for providing security for electronic signatures which can provide information regarding the origination or originating address of the respective computer or communication device, for an electronic signatures), electronic initial(s), electronic identification code(s), or electronic identification indicia, which are utilized in a transaction, agreement, or contract.

It is another object of the present invention to provide an apparatus and method for providing security for electronic signatures which can utilize, or which can be utilized in conjunction with, intelligent agents, software agents, mobile agents, and/or related technologies.

It is still another object of the present invention to provide an apparatus and method for providing security for electronic signatures which can be agent-based.

It is yet another object of the present invention to provide an apparatus and method for providing security for electronic signatures which can be programmed to be self-activating and/or activated automatically.

It is another object of the present invention to provide an apparatus and method for providing security for electronic signatures which can be programmed to automatically generate and/or transmit e-mail messages, electronic message transmissions, electronic notification transmissions, telephone calls, facsimile transmission, or any other communications, messages, and/or transmissions.

It is still another object of the present invention to provide an apparatus and method for providing security for electronic signatures which can provide information which can contain appropriate links, hyperlinks, and/or forwarding information, to any party or information.

It is yet another object of the present invention to provide an apparatus and method for providing security for electronic signatures which can be utilized in conjunction with electronic commerce technologies and security methods, techniques and technologies.

It is another object of the present invention to provide an apparatus and method for providing security for electronic signatures which can be utilized in order to monitor or record information regarding interactions, negotiations, and/or deals reached, between individuals, entities, parties, and/or counter parties.

It is still another object of the present invention to provide an apparatus and method for providing security for electronic signatures which can provide any and/or all of the herein-described processing routines, processing functions, and/or other services, which are described as being provided for or in conjunction with electronic signatures, for electronic initials, electronic identification code(s), or electronic identification indicia.

It is yet another object of the present invention to provide an apparatus and method for providing security for electronic signatures which can count the number of times a respective electronic signature(s), electronic initial(s), electronic identification code(s), electronic identification information, and/or electronic identification indicia, have been used in authorized transactions.

It is another object of the present invention to provide an apparatus and method for providing security for electronic signatures which can count the number of times in which the respective electronic signature(s), electronic initial(s), electronic identification code(s), electronic identification information, and/or electronic identification indicia, have been attempted to be used in unauthorized transactions.

It is still another object of the present invention to provide an apparatus and method for providing security for electronic signatures which can record and/or store any information regarding the use, attempted use, authorized use, approved use, unauthorized use, and/or unapproved use, of any of the respective electronic signature(s), electronic initial(s), electronic identification code(s), electronic identification information, and/or electronic identification indicia.

It is yet another object of the present invention to provide an apparatus and method for providing security for electronic signatures which can cancel or deactivated the use or usage of an electronic signature(s), electronic initial(s), electronic identification code(s), electronic identification information, and/or electronic identification indicia, upon determining that it has been used, that it is being used, and/or that it has attempted to be used, in an unauthorized manner.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates the user computer of FIG. 1, in block diagram form;

FIG. 4 illustrates the counter party computer of FIG. 1, in block diagram form;

FIGS. 5A, SB and 5C illustrate a preferred embodiment method for utilizing the apparatus of the present invention, in flow diagram form; and

FIGS. 6A and GB illustrate another preferred embodiment method for utilizing the apparatus of the present invention, in flow diagram form.

### DESCRIPTION OF THE PREFERRED EMBODIMENTS

The present invention pertains to an apparatus and a method for providing security for electronic signatures and, in particular, to an apparatus and method for providing security for electronic signatures which can be utilized in order to provide notification to individuals and/or entities of the use or usage of their respective electronic signatures and/or other electronic identification codes and/or indicia and/or which can be utilized to provide control over the use or usage of electronic signatures and/or other electronic identification codes and/or indicia.

The present invention provides an apparatus and method for providing notification to individuals and/or entities of a use or usage of their respective electronic signatures and/or other electronic codes and/or indicia. The present invention can be utilized to provide notification and/or to inform an individual and/or entity of a use or usage of his, her, or its, electronic signature or other electronic information code and/or indicia, in a transaction, to form an agreement, to bind the individual and/or entity to an obligation, and/or to otherwise commit the individual and/or entity to a legal, non-legal, financial, non-financial, and/or any other obligation.

The present invention can also be utilized in order to allow an individual and/or entity to provide control over the usage of his, her, or its, set restrictions, limitations, and/or other parameters, regarding use or usage of his, her, or its, electronic signatures and/or other electronic codes and/or indicia. The apparatus and method of the present invention can also be utilized to allow an individual and/or entity to pre-restrict and/or pre-limit use or usage of his, her, or its, electronic signatures and/or other electronic codes and/or indicia.

The present invention can also be utilized in order to provide a multitude of other security, notification, and/or control, services and/or processing routines in order to provide security for, or related to, electronic signatures and/or other electronic identification codes and/or other indicia.

Applicant hereby incorporates by reference herein the subject matter and teachings of U.S. Provisional Patent Application Ser. No. 60/234,569, filed Sep. 22, 2000, which teaches and discloses an apparatus and method for providing security for electronic signatures.

Applicant hereby incorporates by reference herein the subject matter and teachings of Applied Cryptography, Second Edition, Bruce Schneier, Wiley, 1996. Applicant also incorporates by reference herein the subject matter and teachings of U.S. Pat. No. 6,047,270 which teaches and discloses an apparatus and method for providing account security. Applicant also incorporates by reference herein the subject matter and teachings of U.S. Pat. No. 5,903,830 which teaches and discloses a transaction security apparatus and method. Applicant also incorporates by reference herein the subject matter and teachings of U.S. Pat. No. 5,878,337 which teaches and discloses a transaction security apparatus and method.

As used herein, the terms “electronic signature”, “digital signature”, “electronic initial(s)”, “digital initial(s)”, “electronic identification code(s)”, “digital identification code(s)”, “electronic identification indicia”, “digital identification indicia”, as well as an “electronic representation of a handwritten signature”, “digital representation of a handwritten signature”, or the plural of same, refer to any electronic signature(s), digital signature(s), electronic initial(s), digital initial(s), electronic identification code(s), digital identification code(s), electronic identification indicia, digital identification indicia, as well as an electronic representation(s) of a handwritten signature(s) and/or a digital representation(s) of a handwritten signature(s), described herein as well as otherwise.

As used herein, the terms “electronic initial” or “digital initial” refer to electronic data and/or information which can be utilized in conjunction with, as a compliment to, as an addition to, and/or as an addendum to, an electronic signature and/or a digital signature. The electronic initial and/or the digital initial can be utilized in conjunction with a respective electronic signature and/or digital signature so as to facilitate changes or updates to a transaction without having to process the electronic or digital signature in its entirety subsequent to an initial transaction involving same and/or a previous processing operation involving same.

As used herein, the terms “user”, “individual”. “entity”, or the plurals of same, refer to a user, individual, entity, party, contracting individual, contracting entity, party to a transaction, counter party to a transaction, and/or any agent and/or other party who can act for, or on behalf of, any user, individual, entity, party, contracting individual, contracting entity, party to a transaction, and/or counter party to a transaction.

The terms “signature processing party”, “signature processing entity”, “signature processing individual”, “signature processing authority”, “signature processing agent”, “central processing facility”, “authority”, “processing agent”, “arbitrator”, “central processing computer”, or the plurals of same, refer to any of the herein-described individuals and/or entities who or which process any of the herein-described electronic signatures, electronic signature information, electronic identification codes and/or other indicia.

The terms “user”, “operator”, and/or the plurals of same, refer to any user, users, operator, or operators, of any of the user computers or communication devices, central processing computers or communication devices, merchant computers or communication devices, provider computers or communication devices, counter party computers or communication devices, and/or any other computers or communication devices described herein as being utilized in conjunction with the present invention.

The terms “counter party”, “provider”, “goods provider”, “products provider”, “services provider”, “transaction party”, “transaction counter party”, “merchant”, “vendor”, “buyer”, “seller”, and/or any other party to a transaction or agreement, and/or an agent of other third party who or which acts for, or on behalf of, any of the herein-described counter parties, providers, goods providers, products providers, services providers, transaction parties, transaction counter parties, merchants, vendors, buyers, sellers.

The electronic signatures, digital signatures, electronic initials, digital initials, electronic identification codes, digital identification codes, electronic identification indicia and/or digital identification indicia, can be utilized in any transaction, contract, agreement, and/or other relationship creation activity, for or involving a transaction of any kind, a commercial transaction, a non-commercial transaction, a financial transaction, a transaction on a financial and/or a brokerage account, a non-financial transaction, a transaction involving the buying, selling, trading, bartering, giving, and/or gifting, of any goods, products, and/or services, which can be the subject of commerce and/or otherwise, non-financial transactions, contractual agreements, contractual relationships, and/or any other agreement, relationship, and/or activity, which can create a liability, liabilities, an obligation, and/or obligations, of any kind or type, financial and/or nonfinancial, and/or any other type.

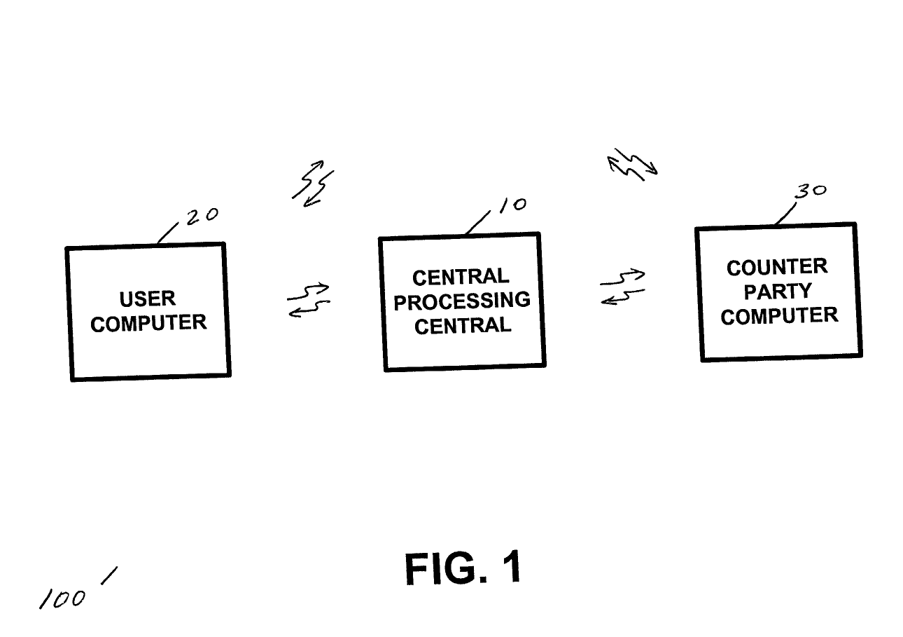

FIG. 1 illustrates the apparatus of the present invention which is designated generally by the reference numeral 100, in block diagram form.

The apparatus 100 includes a central processing computer or server computer 10 (hereinafter referred to as “central processing computer 10”). The central processing computer 10 can provide control over the apparatus 100 and can perform various processing operations for providing any of the various processing routines and/or services described herein. The central processing computer 10 can also provide various services and/or functionality for or regarding any of the individuals and/or entities who or which utilize the apparatus and method of the present invention.

The central processing computer 10, in the preferred embodiment, can be any suitable computer, network computer, or computer system, for providing service for the various individuals and/or entities who or which utilize the apparatus and method of the present invention and/or any of the respective computers and/or communication devices associated therewith.

In the preferred embodiment, any number of central processing computers 10 can be utilized in order to provide the processing and/or servicing functions described herein. The central processing computer(s) 10 may be linked to other central processing computers or may be stand alone devices.

Each central processing computer 10 may be a network computer, a personal computer, and/or any other communication device, suitable for allowing the central processing computer 10 to communicate with and/or to interact with any of the user computers 20, any of the counter party computers 30, and/or any of the other central processing computers 10, described herein.

The central processing computer 10 can also be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for performing the functions of the central processing computer 10 as described herein.

A given central processing computer 10 may service a particular user, users, individual, individuals, entity, or entities. A central processing computer 10 can also be utilized by, and/or operated by any of the signature processing parties, signature processing entities, signature processing individuals, signature processing authorities, signature processing agents, central processing facilities, authorities, processing agents, and/or arbitrators, described herein.

A central processing computer 10 may also be dedicated to service any one or group of the above described individuals and/or entities.

The apparatus 100, in the preferred embodiment, also includes one or more user computers or user communication devices 20 (hereinafter referred to as “user computer 20” or “user computers 20”) with each user computer 20 being associated with an user, individual, entity, or group of users, individuals, or entities. Any user computer 20 may also be associated with a number of users, individuals, and/or entities, depending upon the application. The user computer 20 can be utilized by any user, individual, and/or entity, and/or any agent and/or third party who is authorized to act on behalf of the user, individual, and/or entity, desiring to utilize the apparatus 100.

Each user computer 20 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the user computer 20 to communicate with and/or to interact with any of the central processing computer(s) 20 and/or any of the counter party computers 30 or communication devices described herein. Each user computer 20 can be utilized to transmit information to, and receive information from, any of the vendor computer(s) 10, central processing computers 20, and/or any other user computers 30 described herein.

In the present invention, any number of user computers 20 may be utilized. In the present invention, each user, individual, or entity, utilizing the present invention may have one or more user computers 20 associated therewith.

The apparatus 100, in the preferred embodiment, also includes one or more counter party computers or counter party communication devices 30 (hereinafter referred to as “counter party computer 30” or “counter party computers 30”) with each counter party computer 30 being associated with a counter party, a provider, a goods provider, a products provider, a services provider, a transaction party, a transaction counter party, a merchants, vendors, a buyer, a seller, and/or an agent of other third party who or which acts for, or on behalf of, any of the above-described counter parties, providers, goods providers, products providers, services providers, transaction parties, transaction counter parties, merchant, vendors, buyers, sellers, agents, and/or third parties.

Any counter party computer 30 may also be associated with a number of counter parties, providers, goods providers, products providers, services providers, transaction parties, transaction counter parties, merchant, vendors, buyers, sellers, agents, and/or third parties, depending upon the application. The counter party computer 30 can also be utilized by any user, individual, and/or entity, and/or any agent and/or third party, who is authorized to act on behalf of the counter parties, providers, goods providers, products providers, services providers, transaction parties, transaction counter parties, merchant, vendors, buyers, sellers, agents, and/or third parties, desiring to utilize the apparatus 100.

Each counter party computer 30 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the counter party computer 30 to communicate with and/or to interact with any of the central processing computer(s) 10, any of the user computers 20, and/or any of the other counter party computers 30 or communication devices described herein.

Each counter party computer 30 can be utilized to transmit information to, and receive information from, any of the central processing computer(s) 10, the user computers 20, and/or any other counter party computer 30, described herein.

In the present invention, any number of counter party computers 30 may be utilized. In the present invention, each counter party, provider, goods provider, products provider, services provider, transaction party, transaction counter party, merchant, vendor, buyer, seller, agent, and/or third party, utilizing the present invention may have one or more counter party computers 30 associated therewith.

The central processing computer (s) 10, the user computers 20, and/or the counter party computers 30, can communicate with each other via any suitable communication network or system.

Each of the central processing computer(s) 10, the user computers 20, and/or the counter party computers 30, can communicate and/or interact with any central processing computer(s) 10, the user computers 20, and/or the counter party computers 30.

In the preferred embodiment, the apparatus 100 can be utilized on, over, or in conjunction with, the Internet and/or the World Wide Web. The apparatus 100 can also be utilized on, over, or in conjunction with, any appropriate communication networks or systems including, but not limited to, network communication systems, telephone communication networks or systems, wired or line connected communication networks or systems, wireless communications networks or systems, cellular communication networks or systems, digital communication networks or systems, personal communication networks or systems, personal communication services (PCS) networks or systems, satellite communication networks or systems, broad band communication networks or systems, bluetooth communications networks or systems, low earth orbiting (LEO) satellite networks or systems, and/or public switched telephone networks or systems.

The apparatus and method of the present invention can be utilized on, over, and/or in conjunction with, a wireless communication network or system, a wired or line-connected communication network or system, or any combination of a wireless communication network or system and a wired or line-connected communication network or system.

The present invention, in the preferred embodiment, can also utilize wireless Internet and/or World Wide Web services, equipment and/or devices. Any of the central processing computer~s) 10, the user computers 20, and/or the counter party computers 30, in the preferred embodiment, can have a web site or web sites associated therewith.

In the preferred embodiment, each of central processing computer(s) 10, the user computers 20, and/or the counter party computers 30, can be equipped with any and/or all hardware and/or software necessary and/or desirable for facilitating the operation of the apparatus 100 as described herein.

In the preferred embodiment, each of the central processing computer(s) 10, the user computers 20, and/or the counter party computers 30, can transmit and/or receive data and/or information using TCP/IP, as well as any other Internet and/or World Wide Web, protocols, including wireless protocols as well as non-wireless protocols.

The central processing computer(s) 10, the user computers 20, and/or the counter party computers 30, in the preferred embodiment, can be linked directly or indirectly with any other central processing computer(s) 10, the user computers 20, and/or the counter party computers 30. Any of the herein-described computers may communicate with any other computer in a bi-directional manner.

In any and/or all of the embodiments described herein, any of the computer to computer communications, and/or any of the communications which can occur between any of the herein-described individuals and/or entities and/or their respective computers, can be made and/or can be effected by an e-mail transmission, an e-mail message, an electronic transmission, a telephone message, a letter mail delivery, a telephone transmission, a facsimile transmission, a beeper or a pager message, and/or via any other notification means or method. Any and/or all of the communications which can occur between any of the herein-described computers and/or the individuals and/or entities associated therewith can contain text information, video information, audio information, audio/video information, and/or any combination of same.

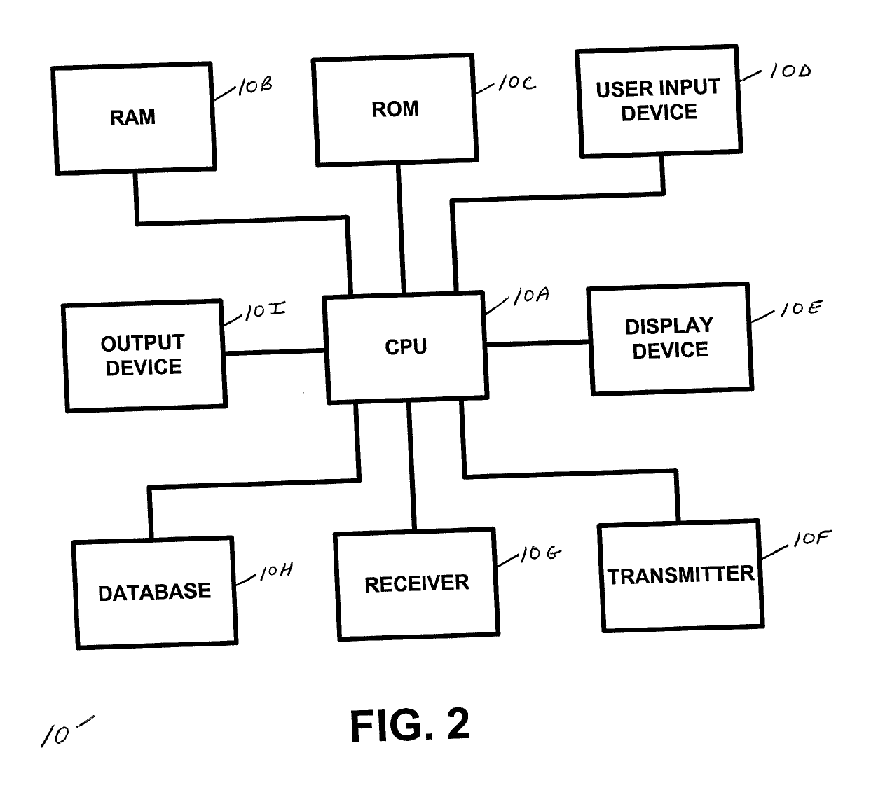

FIG. 2 illustrates the central processing computer 10, in block diagram form. The central processing computer 10, in the preferred embodiment, is a network computer, server computer, or computer system, which is utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The central processing computer 10 also includes a display device 10E for displaying data and/or information to a user or operator.

The central processing computer 10 also includes a transmitter(s) 10F, for transmitting signals, data and/or information to any one or more of the user computers 20, the counter party computers 30, and/or any of the other central processing computers 10, which may be utilized in conjunction with the present invention. The central processing computer 10 also includes a receiver 10G, for receiving signals, data and/or information from any one or more of the user computers 20, the counter party computers 30, and/or any of the other central processing computers 10, which may be utilized in conjunction with the present invention.

The central processing computer 10 also includes a database 10H. The database 10H can contain any and/or all of the data and/or information needed and/or desired for performing any of the herein-described processing routines and/or functions. The database 10H can also contain data and/or information for or regarding any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, including, but not limited to the name, address, telephone number, beeper number, pager number, facsimile number, e-mail address, server address, domain name(s), uniform resource locator(s) URL(s), and/or any other contact information, for any of the above-described and respective individuals and/or entities.

The database 10H can also contain electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 10H can also contain the electronic signatures), electronic initial(s), electronic identification code(s), and/or any other electronic identification indicia, for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 10H can also contain cryptography and encryption data and/or information for processing any of the herein-described transactions, electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities. Applicant hereby incorporates by reference herein the subject matter and teachings of Applied Cryptography, Second Edition, Bruce Schneier, Wiley, 1996.

The database 10H can also contain data and/or information regarding transaction accounts for, and/or transactions which can occur on the respective accounts of, any of the herein-described electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 10H can also contain data and/or information regarding the computers, the user computers, the user communication devices, the counter party computers, the counter party communication devices, and/or any of the central processing computer, which can be utilized in conjunction with the present invention, which data and/or information can include, but is not limited to, identification numbers, communication addresses, security information, transaction restrictions or limitation associated with the computer, and/or any other data and/or information for utilizing the apparatus and method of the present invention as described herein.

The database 10H can also contain data and/or information, including software programs, software algorithms, processing data and/or information, and/or any other data and/or information, which can be utilized in processing electronic signatures and/or electronic signature information, and/or any of the other electronic identification information described herein.

The database 10H can also contain data and/or information for notifying any of the electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, of the use or usage of his, her, its, electronic signatures and/or other electronic identification information. The database 10H can include, for example, a telephone number(s), beeper number(s), pager number(s), e-mail address or e-mail addresses, mail addresses, and/or any other contact information.

The database 10H can also contain data and/or information regarding restrictions and/or limitations on the use or usage of the herein-described electronic signatures, electronic initials, electronic identification information, electronic identification indicia, including but not limited to, the types of transactions may be entered into, the types of transactions which are authorized, the types of transactions which are not authorized, authorized transaction times, unauthorized transaction times, authorized transaction parties, authorized transaction counter parties, unauthorized transaction parties, unauthorized transaction counter parties, authorized transactions areas, geographic areas, and/or geographic regions, unauthorized transactions areas, geographic areas, and/or geographic regions, authorized transaction amounts, authorized transaction obligations, unauthorized transaction amounts, unauthorized transaction obligations, authorized transaction types, unauthorized transaction types, authorized goods, products, and/or services, which can be the subject a transaction, an agreement, and/or a contract, and unauthorized goods, products, and services, which can be the subject of a transaction, an agreement, and/or a contract, and/or any other restrictions and/or limitations regarding the use or usage of any of the herein-described electronic signatures, electronic initials, electronic identification information, electronic identification indicia.

The database 10H can also contain any other data and/or information which may be needed and/or desired for performing any of the processing routines, operations, and/or functions, described herein.

With reference once again to FIG. 2, the central processing computer 10 also includes an output device 10I such as a printer, a modem, a fax/modem, or other output device, for providing data and/or information to the operator or user of the central processing computer 10 or to a third party or third party entity.

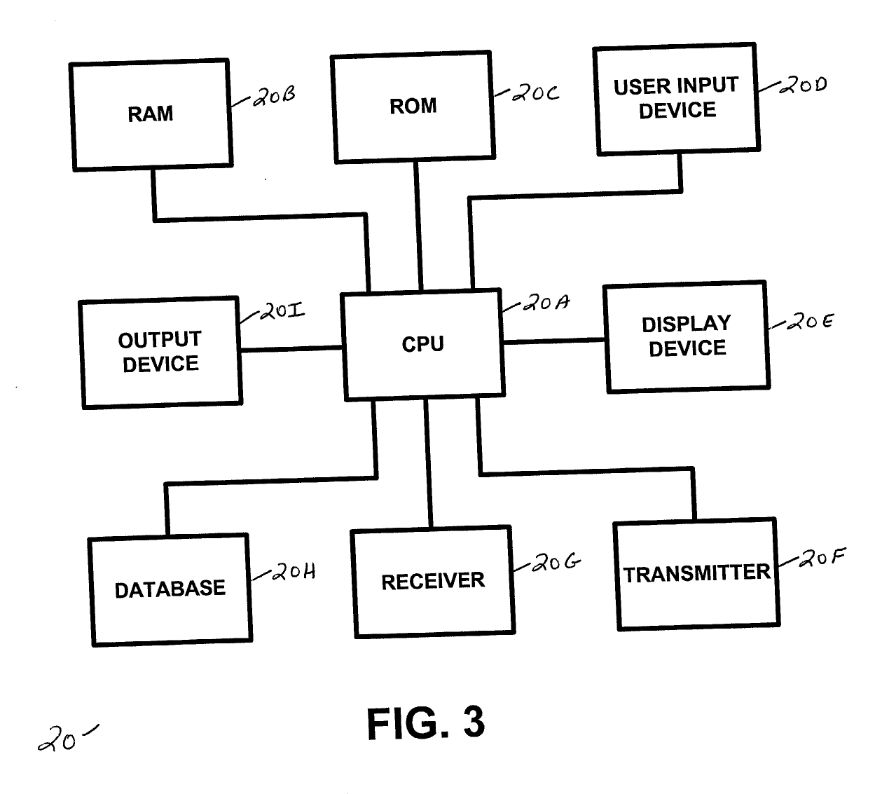

FIG. 3 illustrates the user computer 20, in block diagram form. In the preferred embodiment, the user computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user computer 20 also includes a random access memory device(s) 20B (RAM) and a read only memory device(s) 20C (ROM), each of which is connected to the CPU 20A, a user input device 20D, for entering data and/or commands into the user computer 20, which includes any one or more of a keyboard, a scanner, a user pointing device, such as, for example, a mouse, a touch pad, and/or an audio input device and/or a video input device, etc., if desired, which input device(s) is also connected to the CPU 20A. The user computer 20 also includes a display device 20E for displaying data and/or information to a user or operator.

The user computer 20 also includes a transmitter(s) 20F, for transmitting signals, data and/or information to any one or more of the central processing computers 10, the counter party computers 30, and/or any of the other user computers 20, which may be utilized in conjunction with the present invention. The user computer 20 also includes a receiver 20G, for receiving signals, data and/or information from any one or more of the central processing computers 10, the counter party computers 30, and/or any of the other user computers 20, which may be utilized in conjunction with the present invention.

The user computer 20 also includes a database 20H. The database 20H can contain any and/or all of the data and/or information needed and/or desired for performing any of the herein-described processing routines and/or functions. The database 20H can also contain data and/or information for or regarding any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, including, but not limited to the name, address, telephone number, beeper number, pager number, facsimile number, e-mail address, server address, domain name(s), uniform resource locator(s) URL(s), and/or any other contact information, for any of the above-described and respective individuals and/or entities.

The database 20H can also contain electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 20H can also contain the electronic signature(s), electronic initial(s), electronic identification code(s), and/or any other electronic identification indicia, for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 20H can also contain cryptography and encryption data and/or information for processing any of the herein-described transactions, electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 20H can also contain data and/or information regarding transaction accounts for, and/or transactions which can occur on the respective accounts of, any of the herein-described electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 20H can also contain data and/or information regarding the computers, the user computers, the user communication devices, the counter party computers, the counter party communication devices, and/or any of the central processing computer, which can be utilized in conjunction with the present invention, which data and/or information can include, but is not limited to, identification numbers, communication addresses, security information, transaction restrictions or limitation associated with the computer, and/or any other data and/or information for utilizing the apparatus and method of the present invention as described herein.

The database 20H can also contain data and/or information, including software programs, software algorithms, processing data and/or information, and/or any other data and/or information, which can be utilized in processing electronic signatures and/or electronic signature information, and/or any of the other electronic identification information described herein.

The database 20H can also contain data and/or information for notifying any of the electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, of the use or usage of his, her, its, electronic signatures and/or other electronic identification information. The database 10H can include, for example, a telephone number(s), beeper number(s), pager number(s), e-mail address or e-mail addresses, mail addresses, and/or any other contact information.

The database 20H can also contain data and/or information regarding restrictions and/or limitations on the use or usage of the herein-described electronic signatures, electronic initials, electronic identification information, electronic identification indicia, including but not limited to, the types of transactions may be entered into, the types of transactions which are authorized, the types of transactions which are not authorized, authorized transaction times, unauthorized transaction times, authorized transaction parties, authorized transaction counter parties, unauthorized transaction parties, unauthorized transaction counter parties, authorized transactions areas, geographic areas, and/or geographic regions, unauthorized transactions areas, geographic areas, and/or geographic regions, authorized transaction amounts, authorized transaction obligations, unauthorized transaction amounts, unauthorized transaction obligations, authorized transaction types, unauthorized transaction types, and/or any other restrictions and/or limitations regarding the use or usage of any of the herein-described electronic signatures, electronic initials, electronic identification information, electronic identification indicia.

The database 20H can also contain any other data and/or information which may be needed and/or desired for performing any of the processing routines, operations, and/or functions, described herein.

With reference once again to FIG. 3, the user computer 20 also includes an output device 20I such as a printer, a modem, a fax/modem, or other output device, for providing data and/or information to the operator or user of the user computer 20 or to a third party or third party entity.

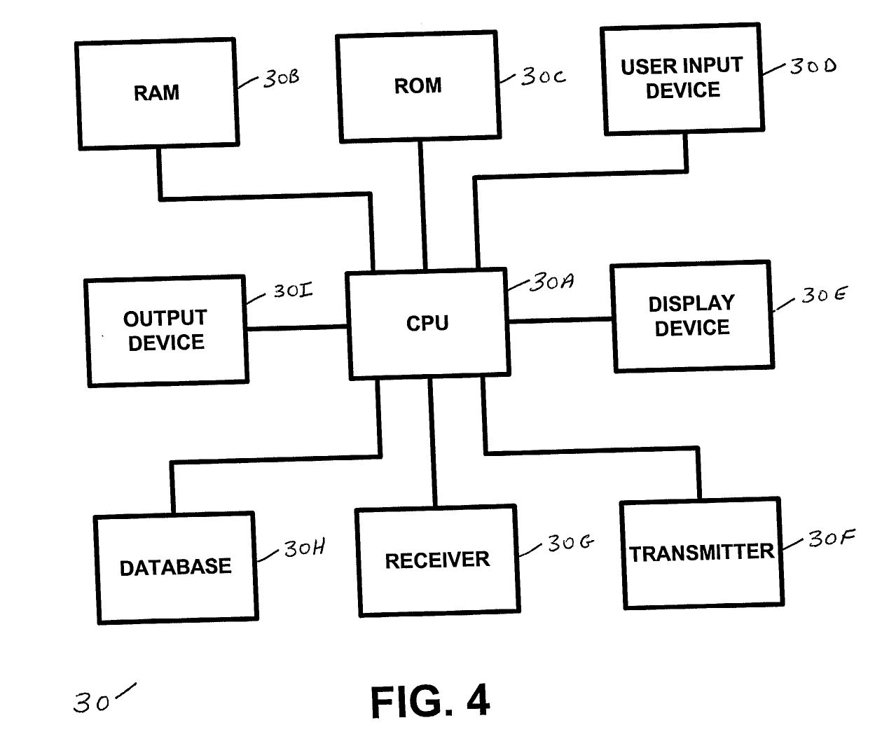

FIG. 4 illustrates the counter party computer 30, in block diagram form. In the preferred embodiment, the counter party computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The counter party computer 30 also includes a random access memory device(s) 30B (RAM) and a read only memory device(s) 30C (ROM), each of which is connected to the CPU 30A, a user input device 20D, for entering data and/or commands into the counter party computer 30, which includes any one or more of a keyboard, a scanner, a user pointing device, such as, for example, a mouse, a touch pad, and/or an audio input device and/or a video input device, etc., if desired, which input device(s) is also connected to the CPU 30A. The counter party computer 30 also includes a display device 30E for displaying data and/or information to a user or operator.

The counter party computer 30 also includes a transmitter(s) 30F, for transmitting signals, data and/or information to any one or more of the central processing computers 10, the user computers 20, and/or any of the other counter party computers 30, which may be utilized in conjunction with the present invention. The counter party computer 30 also includes a receiver 30G, for receiving signals, data and/or information from any one or more of the central processing computers 10, the user computers 20, and/or any of the other counter party computers 30, which may be utilized in conjunction with the present invention.

The counter party computer 30 also includes a database 30H. The database 30H can contain any and/or all of the data and/or information needed and/or desired for performing any of the herein-described processing routines and/or functions.

The database 30H can also contain data and/or information for or regarding any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, including, but not limited to the name, address, telephone number, beeper number, pager number, facsimile number, e-mail address, server address, domain name(s), uniform resource locator(s) URL(s), and/or any other contact information, for any of the above-described and respective individuals and/or entities.

The database 30H can also contain electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 30H can also contain the electronic signature(s), electronic initial(s), electronic identification code(s), and/or any other electronic identification indicia, for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 30H can also contain cryptography and encryption data and/or information for processing any of the herein-described transactions, electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 30H can also contain data and/or information regarding transaction accounts for, and/or transactions which can occur on the respective accounts of, any of the herein-described electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities.

The database 30H can also contain data and/or information regarding the computers, the user computers, the user communication devices, the counter party computers, the counter party communication devices, and/or any of the central processing computer, which can be utilized in conjunction with the present invention, which data and/or information can include, but is not limited to, identification numbers, communication addresses, security information, transaction restrictions or limitation associated with the computer, and/or any other data and/or information for utilizing the apparatus and method of the present invention as described herein.

The database 30H can also contain data and/or information, including software programs, software algorithms, processing data and/or information, and/or any other data and/or information, which can be utilized in processing electronic signatures and/or electronic signature information, and/or any of the other electronic identification information described herein.

The database 30H can also contain data and/or information for notifying any of the electronic signature information, electronic initial information, electronic identification codes, and/or any other electronic identification indicia for any of the herein-described users, individuals, entities, parties, contracting individuals, contracting entities, parties to a transaction, counter parties to a transaction, counter parties, providers, goods providers, products providers, services providers, transaction parties, transaction counter parties, merchants, vendors, buyers, sellers, signature processing parties, signature processing entities, signature processing individuals, signature processing authorities, signature processing agents, central processing facilities, authorities, processing agents, arbitrators, and/or any agents and/or third parties who or which can act for, or on behalf of, any of the above-described individuals or entities, of the use or usage of his, her, its, electronic signatures and/or other electronic identification information. The database 10H can include, for example, a telephone number(s), beeper number(s), pager number(s), e-mail address or e-mail addresses, mail addresses, and/or any other contact information.

The database 30H can also contain data and/or information regarding restrictions and/or limitations on the use or usage of the herein-described electronic signatures, electronic initials, electronic identification information, electronic identification indicia, including but not limited to, the types of transactions may be entered into, the types of transactions which are authorized, the types of transactions which are not authorized, authorized transaction times, unauthorized transaction times, authorized transaction parties, authorized transaction counter parties, unauthorized transaction parties, unauthorized transaction counter parties, authorized transactions areas, geographic areas, and/or geographic regions, unauthorized transactions areas, geographic areas, and/or geographic regions, authorized transaction amounts, authorized transaction obligations, unauthorized transaction amounts, unauthorized transaction obligations, authorized transaction types, unauthorized transaction types, and/or any other restrictions and/or limitations regarding the use or usage of any of the herein-described electronic signatures, electronic initials, electronic identification information, electronic identification indicia.

The database 30H can also contain any other data and/or information which may be needed and/or desired for performing any of the processing routines, operations, and/or functions, described herein.

With reference once again to FIG. 4, the counter party computer 30 also includes an output device 30I such as a printer, a modem, a fax/modem, or other output device, for providing data and/or information to the operator or user of the counter party computer 30 or to a third party or third party entity.

In a preferred embodiment, the apparatus and method of the present invention can be utilized in order to provide notification to an individual and/or an entity of a use or usage of his, her, or its, electronic signature(s), electronic initials, and/or other electronic identification code(s) and/or other indicia.

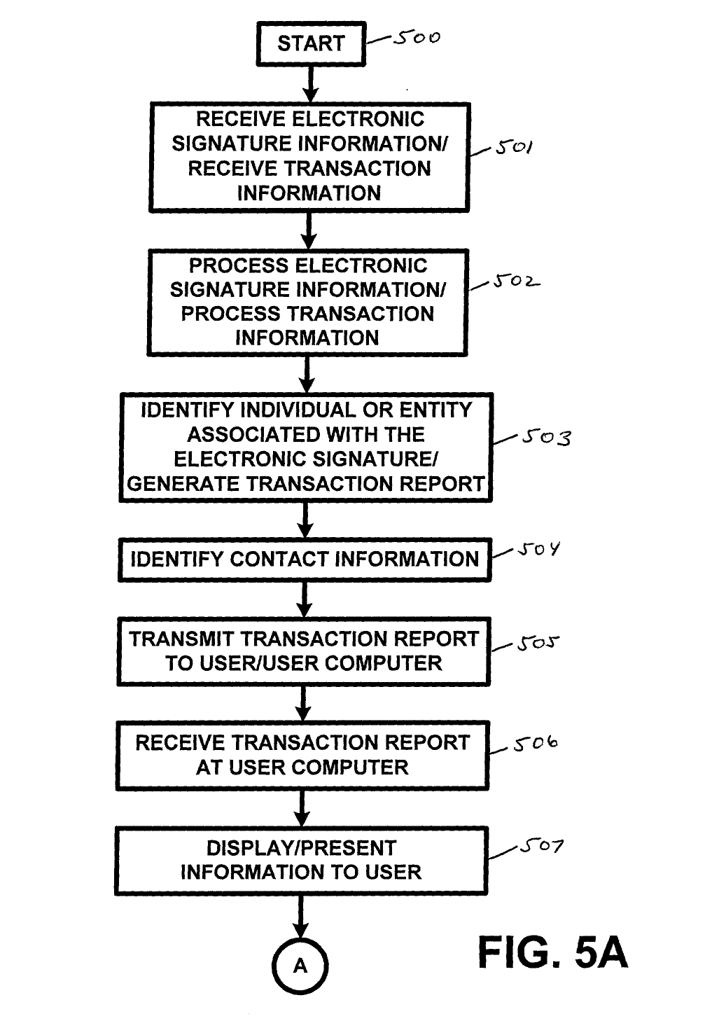

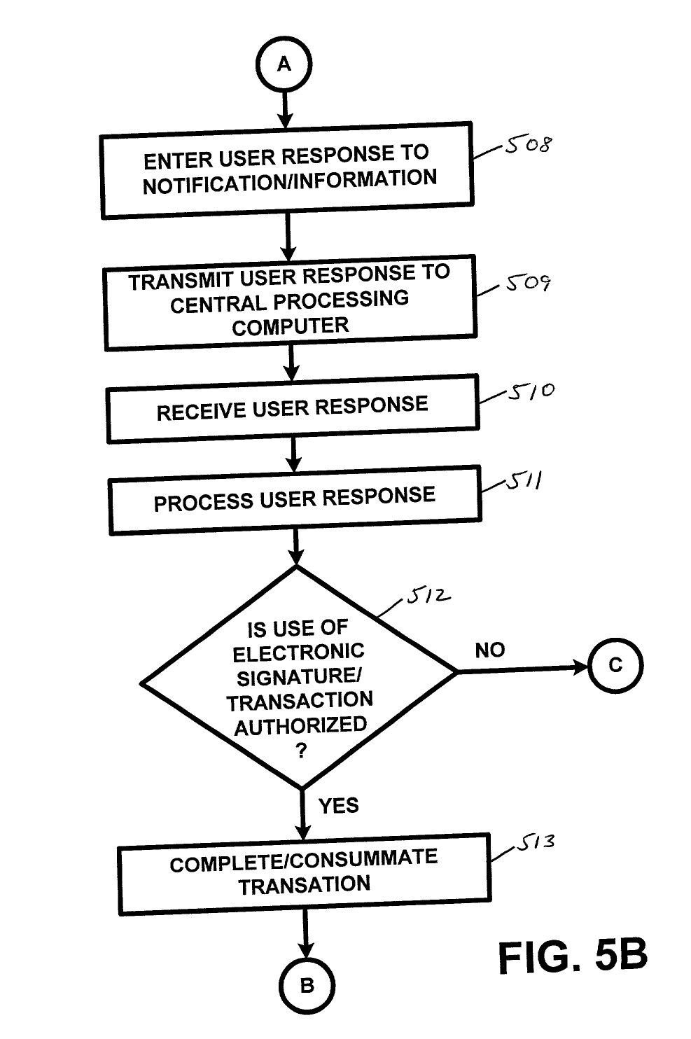

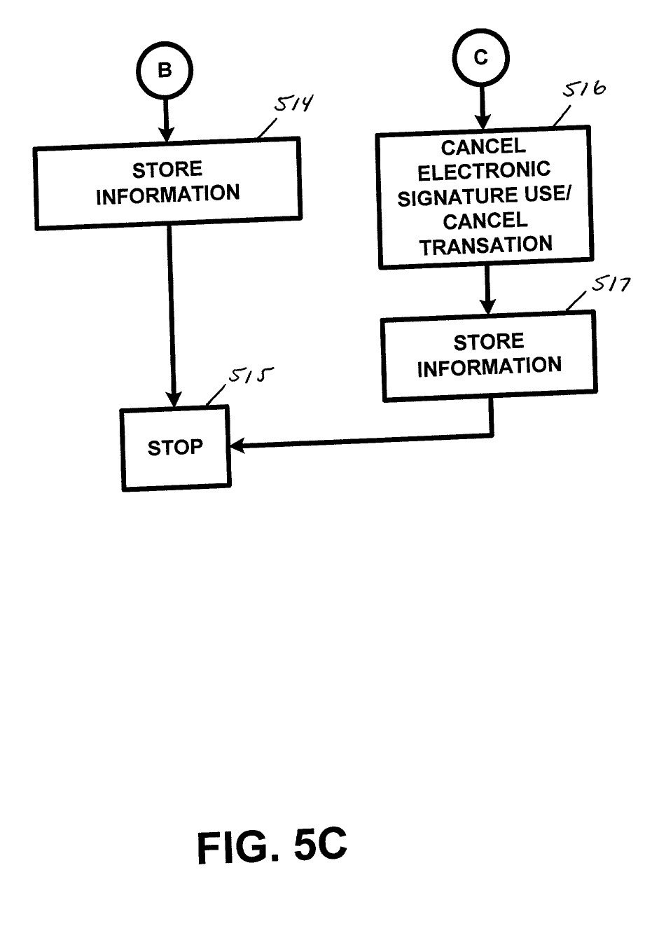

FIGS. 5A, 5B and 5C illustrate a preferred embodiment method for utilizing the apparatus 100 of the present invention. In the embodiment of FIG. 5, the apparatus can be utilized to provide notification to an individual and/or an entity when an electronic signature associated with the individual or entity is utilized in a transaction. The apparatus 100 can also be utilized in order to provide notification to an individual or entity when an electronic initial, electronic identification information, and/or other electronic indicia associated with and/or belonging to the individual or entity is utilized and/or is being utilized for the purpose of entering into a transaction, an agreement, a contract, and/or any other relationship which may result in and/or involve the creation of a liability or liabilities and/or an obligation and/or obligations of any type for the individual or entity.

In a preferred embodiment of the present invention, as well as any of the other preferred embodiments described herein, the individual, individuals, entity, and/or entities, described herein can register with the central processing computer 10 and/or can be registered with the central processing computer 10. The individual or entity can register any one or more of an electronic signature(s), electronic initial(s), electronic identification code(s), electronic identification information, and/or electronic identification indicia, along with the individual's or entity's name, identification information, contact information, telephone number, e-mail address, mailing address, beeper number, facsimile number, e-mail address, and/or any other contact information.

The individual or entity can also provide information regarding restrictions and/or limitations for, or involving the use or usage of any of his, her, or its, electronic signature(s), electronic initial(s), electronic identification code(s), electronic identification information, and/or electronic identification indicia. For example, the individual or entity can provide restrictions as the type or kinds of transactions which he, she, or it, authorizes his, her, or its electronic signature(s), electronic initial(s), electronic identification code(s), electronic identification information, and/or electronic identification indicia, can be utilized.

The individual or entity can also provide restrictions regarding the types or kinds of transactions which are not authorized. For example, the individual can specify that only the purchases or sales of certain goods, products, and/or services, are authorized with the, or a, respective electronic signature(s), electronic initial(s), electronic identification code(s), electronic identification information, and/or electronic identification indicia, while, for example, financial transactions, brokerage transactions, the purchase of real estate, the assumption of the debt, a co-signing for the debt of another, are not authorized.

The restrictions can also include times of authorized use, times of unauthorized use, places or areas of authorized use, places or areas of unauthorized, authorized parties or counter parties with who transactions may be entered into, unauthorized parties or counter parties with who transactions may be entered into, etc. The restrictions can also include any restrictions which can be placed upon transactions, agreements, and/or contracts, which can involve any of the herein-described electronic signatures, electronic initials, electronic identification codes, electronic identification information, and/or electronic identification indicia.

The individual or entity can also provide information regarding limitations on use or usage of the respective electronic signature(s), electronic initial(s), electronic identification code(s), electronic identification information, and/or electronic identification indicia. The limitations can include the amount of a transaction(s), the time of a transaction, the place of a transaction, the types of goods, products, and/or services, and/or any other limitations which can be placed upon transactions, agreements, and/or contracts, which can involve any of the herein-described electronic signatures, electronic initials, electronic identification codes, electronic identification information, and/or electronic identification indicia.

The restrictions and limitations can also involve the same restrictions and/or limitations as the terms “restriction” and “limitation”, or the plural of same, are defined herein as being used interchangeably.

With reference to FIG. 5, the operation of the apparatus commences at step 500. At step 501, central processing computer 10 will receive the electronic signature or the electronic signature information. At step 501, the central processing computer 10 can also receive any information regarding the respective transaction, agreement, or contract, in conjunction with which the electronic signature and/or the electronic signature information is being utilized.

The electronic signature or the electronic signature information can be accompanied by information regarding the transaction, the agreement, and/or the contract, including details or specifics regarding the transaction, the agreement, or the contract, the subject matter of the transaction, the agreement, or the contract, and/or the parties and/or counter party or counter parties involved in the transaction, the agreement, or the contract. The information can include any and/or all of the details regarding the transaction, the agreement, or the contract, as well as the parties and/or counter parties involved in same.

The electronic signature or the electronic signature information can be received from the individual or entity, from the user computer 20 associated with the individual or entity, from the counter party to the transaction, the agreement, or the contract, and/or from the counter party computer 30 associated with the counter party computer 30.

At step 502, the central processing computer 10 will process the electronic signature and/or the electronic signature information which is received at step 501.

In the embodiment of FIG. 5, as well as in any and/or all of the embodiments described herein, the central processing computer 10 can process the electronic signature or electronic signature information, so as to process same in any appropriate manner, so as to process same for any appropriate manner or purpose, so as to process same in conjunction with a processing of a transaction, an agreement, and/or a contract, and/or so as to identify the electronic signature, the electronic signature information, and/or the origination of the electronic signature or the electronic signature information, by utilizing any processing routines, electronic signature processing routines, cryptographic processing routines, encryption routines, and/or decryption routines which are known by those skilled in the electronic signature and/or cryptography fields or arts. Applicant hereby incorporates by reference herein the subject matter and teachings of Applied Cryptography, Second Edition, Bruce Schneier, Wiley, 1996.

With reference once again to FIG. 5, the central processing computer 10, at step 502, can also process any of the transaction, the agreement, or the contract, information which is also received at step 501.

At step 503, the central processing computer 10 will identify the individual or entity associated with the electronic signature or the electronic signature information. At step 503, the central processing computer 10 can also identify the electronic signature(s) and/or the electronic signature information. In this manner, the central processing computer 10 will determine the individual or entity with whom the electronic signature or the electronic signature information is associated and/or to whom the electronic signature or the electronic signature belongs.

At step 503, the central processing computer 10 can also generate a transaction report which can include information and/or details regarding the transaction, the agreement, or the contract. The transaction report can contain text information, video information, audio information, and/or any combination of text, video and/or audio information.

At step 504, the central processing computer 10 can identify the contact information for providing notification to the individual or entity regarding the fact that the individual's or the entity's electronic signature or electronic signature information is being utilized and/or has been utilized in a transaction, an agreement, or a contract. At step 504, the central processing computer can identify the individual's or the entity's telephone number, beeper number, pager number, e-mail address, mailing address, facsimile number, and/or other contact information.

At step 505, the central processing computer 10 can transmit the transaction report to the user computer 20 or user communication device 20. The central processing computer 10 can generate and send any one or more of a beeper message, a pager message, an e-mail message, a telephone message, a facsimile message or transmission, a letter, and/or any other communication or message to the individual or entity, and/or to a respective communication device 20 and/or communication devices 20.

At step 506, the user communication device 20 associated with the individual or entity can receive the transaction report. At step 507, the information contained in the transaction report can be displayed and/or otherwise presented the individual or entity. The information can be displayed such as in the case involving text and video information. The information can also be played such as in the case of audio information.

At step 508, the individual or entity can enter or make a response to transaction report which response can approve the use of the electronic signature, the electronic signature information, in the transaction, the agreement, or the contract, in whole or in part, or disapprove of the use of the electronic signature, the electronic signature information, in the transaction, the agreement, or the contract, in whole or in part. At step 508, the individual or entity can enter the response into the user communication device 20.

At step 509, the individual or entity can transmit the response to the central processing computer. At step 510, the central processing computer 10 can receive the response. At step 511, the central processing computer 10 can process the response. At step 512, the central processing computer 10 can determine whether any one or more of the use of the electronic signature, the electronic signature information, the transaction, the agreement, or the contract, is authorized or not authorized.

If, at step 512, the central processing computer 10 determines that any one or more of the use of the electronic signature, the electronic signature information, the transaction, the agreement, or the contract, is authorized or approved, then the operation of the central processing computer 10 will proceed to step 513 and the central processing computer will process the information regarding the electronic signature, the electronic signature information, the transaction, the agreement, and/or the contract, so as to complete and/or so as to consummate same.

At step 514, the central processing computer 10 can store any and/or all of the information regarding the use of the electronic signature, the electronic signature information, the transaction, the agreement, or the contract. Thereafter, the operation of the apparatus will cease at step 515.

If, however, at step 512, it is determined that any one or more of the use of the electronic signature, the electronic signature information, the transaction, or the agreement, is not authorized or disapproved, then the operation of the central processing computer 10 will proceed to step 516 and the central processing computer will cancel the use of the electronic signature, the electronic signature information, and/or the transaction, the agreement, or the contract.

At step 517, the central processing computer 10 can store any and/or all of the information regarding the attempted use of the electronic signature, the electronic signature information, the attempted transaction, or the attempted agreement. Thereafter, the operation of the apparatus will cease at step 515.

In another preferred embodiment, the individual or entity can access the central processing computer 10 via the user computer 20 and provide information to the central processing computer 10 which information can be utilized for, and/or to facilitate, a pre-authorization for, or a pre-approval of, the use of any one or more of his, her, or its, electronic signature(s) and/or electronic signature information.

The central processing computer 10 can store the pre-authorization information and/or the pre-approval information in the database 10H. Thereafter, the central processing computer 10 can process a transaction, an agreement, or a contract, in which the electronic signature is being utilized, in accordance with, and/or in conjunction with, the individual's or the entity's instructions regarding the pre-authorization and/or the pre-approval, in order to effectuate the consummation or the completion of the respective transaction, agreement, and/or contract, in accordance with the individual's or the entity's instructions or desires.

The embodiment of FIGS. 5A, 5B and 5C can also be utilized, in the same, a similar, and/or an analogous manner, as described herein with regards to FIG. 5, in conjunction with providing notification regarding the use or use of electronic initials, electronic identification codes, electronic identification information, and/or electronic identification indicia.

An example of how an electronic initial can be utilized in conjunction with an electronic signature can be described in the following manner. Assume, for example, that an individual and a counter party have entered into an agreement involving the sale of a piece of real estate. Assume further that once the electronic signatures have been provided by both parties, that a change or an addendum has to be made or added to the contract for sale, with such change or addendum requiring another electronic signature or an electronic initial. In such an instance, an electronic initial, which can include or contain less than all of the information contained in an associated electronic signature, can be utilized in order to effectuate changes or addendums to the contract for sale without having to re-utilize the previously used electronic signature or without having to utilize a new electronic signature.

In the embodiment of FIG. 5, as well as any of the other embodiments described herein, the central processing computer 10 can count the number of times in which an electronic signature, an electronic initial, an electronic identification code, electronic identification information, and/or electronic identification indicia, has been utilized in a transaction, an agreement, or a contract, in transactions, agreements, or contracts, involving certain parties and/or certain counter parties.

The information regarding the number of times in which a respective electronic signature(s), an electronic initial(s), an electronic identification code(s), electronic identification information, and/or electronic identification indicia, can be stored and can be provided to an individual or entity via an activity report or reports associated with and/or corresponding to the respective electronic signature(s), an electronic initial(s), an electronic identification code(s), electronic identification information, and/or electronic identification indicia.

In another preferred embodiment, the apparatus and method of the present invention can be utilized in order to allow an individual and/or entity to pre-restrict and/or to pre-limit, and/or to otherwise set or establish parameters for use or usage of his, her, or its, electronic signature(s), electronic initials, electronic identification code(s), and/or other electronic identification indicia.

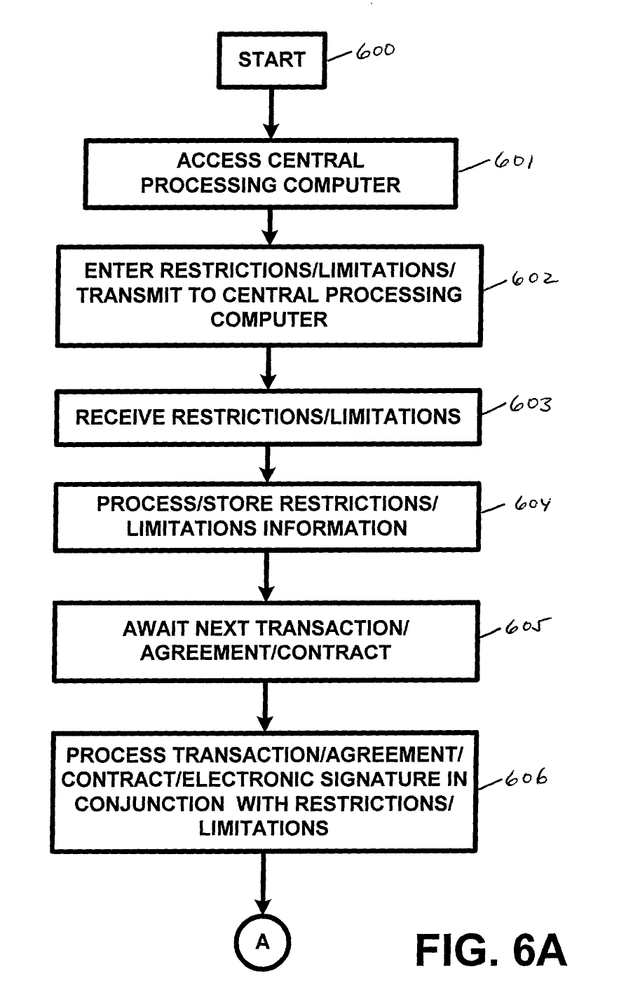

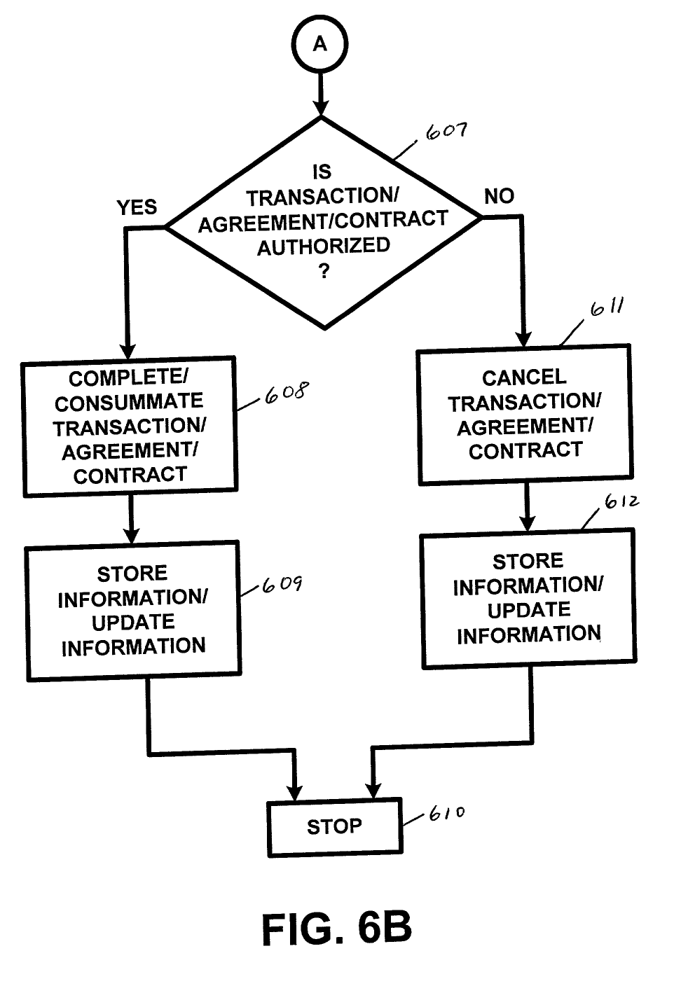

FIGS. 6A and 6B illustrate another preferred embodiment method for utilizing the apparatus 100 of the present invention. In the embodiment of FIGS. 6A and 6B, the apparatus 100 can be utilized in order to allow an individual or an entity pre-restrict and/or pre-limit use or usage of his, her, or its, respective electronic signature(s), an electronic initial(s), an electronic identification code(s), electronic identification information, and/or electronic identification indicia.

With reference to FIGS. 6A and 6B, the operation of the apparatus 100 commences at step 600. At step 601, the individual or entity can access the central processing computer via his, her, or its, user computer 20 or user communication device 20. At step 602, the individual or entity can enter any restrictions and/or limitations regarding the use or usage of any of his, her, or its, electronic signature(s), electronic initial(s), electronic identification code(s), electronic identification information, and/or electronic identification indicia.

The restrictions and/or limitations can include, but are not limited to, the types or kinds of transactions or contracts for which use of the electronic signature(s), electronic initial(s), electronic identification code(s), electronic identification information, and/or electronic identification indicia, are authorized, the types or kinds of transactions, agreements, or contracts, for which use of the electronic signature(s), electronic initial(s), electronic identification code(s), electronic identification information, and/or electronic identification indicia, are not authorized, the goods, products, and/or services, which can be purchased, sold, exchanged, and/or traded, in transactions, agreements, and/or contracts, utilizing the electronic signature(s), electronic initial(s), electronic identification code(s), electronic identification information, and/or electronic identification indicia, authorized parties or counter parties with whom the individual or entity is willing to enter into transactions, agreements, and/or contracts, unauthorized parties or counter parties with whom the individual or entity is not willing to enter into transactions, agreements, and/or contracts, authorized times, places, areas, conditions, conditions precedent, and/or any other conditions or stipulations regarding conditions under which the individual or entity would enter into transactions agreements, and/or contracts, unauthorized times, places, areas, conditions, conditions precedent, and/or any other conditions or stipulations regarding conditions under which the individual or entity would not enter into transactions, agreements, and/or contracts, and/or any other restrictions and/or limitations which may be associated with and/or which can be related to entering and/or conducting transactions involving the use of the electronic signature(s), electronic initial(s), electronic identification code(s), electronic identification information, and/or electronic identification indicia.

The information regarding the restrictions and/or limitations can, at step 602, be transmitted to the central processing computer 10. The information regarding the restrictions and/or limitations can be transmitted to the central processing computer 10 in real-time and/or otherwise. At step 603, the central processing computer 10 can receive the information regarding the restrictions and/or limitations. At step 604, the central processing computer 10 can process and store the information regarding the restrictions and/or limitations.

The information regarding the restrictions and/or limitations can be changed at any time by the individual or entity. The information regarding the restrictions and/or limitations can also be added to and/or supplemented at any time by the individual or entity.

At step 605, the central processing computer 10 will await a next transaction, agreement, or contract, involving or utilizing any one or more of the respective electronic signature(s), electronic initial(s), electronic identification code(s), electronic identification information, and/or electronic identification indicia. Once a transaction, an agreement, or a contract, involving any one of the electronic signature~s), electronic initial(s), electronic identification code(s), electronic identification information, and/or electronic identification indicia, is detected, the operation of the central processing computer 10 will proceed to step 606.

At step 606, the central processing computer 10 will process information regarding the transaction, the agreement, or the contract, in conjunction with information regarding any of the restrictions and/or limitations which may have been previously provided by the individual or entity associated with the respective electronic signature(s), electronic initial(s), electronic identification code(s), electronic identification information, and/or electronic identification indicia.

At step 606, the central processing computer 10 can process the electronic signature or electronic signature information in any appropriate manner, so as to process same in conjunction with a processing of a transaction, an agreement, and/or a contract, so as to identify the electronic signature, the electronic signature information, so as to identify the individual or entity associated with the electronic signature or the electronic signature information, and/or so as to identify the origination of the electronic signature or the electronic signature information, by utilizing any processing routines, electronic signature processing routines, cryptographic processing routines, encryption routines, and/or decryption routines which are known by those skilled in the electronic signature and/or cryptography fields or arts. Applicant hereby incorporates by reference herein the subject matter and teachings of Applied Cryptography, Second Edition, Bruce Schneier, Wiley, 1996.

At step 606, the central processing computer 10 can ascertain and/or determine whether the transaction, the agreement, or the contract, is authorized or not authorized pursuant to the restrictions and/or limitations which are associated with the use or usage of the respective electronic signature(s), electronic initial(s), electronic identification code(s), electronic identification information, and/or electronic identification indicia.

At step 606, the central processing computer can also generate a transaction report containing and/or all of the information concerning the transaction, the agreement, and/or the contract. The transaction report can also contain information regarding whether or not the respective transaction, agreement, and/or contract, has been authorized, approved, unauthorized, or disapproved.

At step 606, the central processing report can also generate a notification report containing information regarding the transaction, the agreement, and/or the contract, and any information concerning the use or the usage of the electronic signatures), the electronic initial(s), the electronic identification code(s), the electronic identification information, and/or the electronic identification indicia, in the transaction, agreement, and/or contract.

At step 607, the central processing computer 10 can determine whether the transaction, agreement, or contract, is authorized or not authorized. If, at step 607, it is determined that the transaction, agreement, or contract, is authorized, the operation of the central processing computer 10 will proceed to step 608. At step 608, the central processing computer 10 will complete or consummate the transaction, the agreement, or the contract.

At step 609, the central processing computer 10 can store any and/or all of the information regarding the transaction, the agreement, or the contract, and update any records or files for or regarding the individual or the entity, and/or update and records for or regarding any of the respective electronic signature(s), electronic initial(s), electronic identification code(s), electronic identification information, and/or electronic identification indicia. Thereafter, the operation of the apparatus will cease at step 610.

If, however, at step 607, it is determined that the transaction, agreement, or contract, is not authorized, the operation of the central processing computer 10 will proceed to step 611. At step 611, the central processing computer 10 will cancel the transaction, agreement, or contract. At step 612, the central processing computer 10 can store any and/or all of the information regarding the attempted transaction, the attempted agreement, or the attempted contract, and update any records or files for or regarding the individual or the entity, and/or update any records for or regarding any of the respective electronic signatures, electronic initial(s), electronic identification code(s), electronic identification information, and/or electronic identification indicia. Thereafter, the operation of the apparatus will cease at step 610.

In another preferred embodiment of FIGS. 6A and 6B, at step 608, the central processing computer 10, prior to completing or consummating the transaction, the agreement, or the contract, can generate a transaction report containing any pertinent information regarding the transaction, the agreement, the contract, the subject matter of the respective transaction, agreement, or contract, the parties, counter party, or counter parties, involved in the respective transaction, agreement, or contract, and/or the respective electronic signature(s), electronic initial(s), electronic identification code(s), electronic identification information, and/or electronic identification indicia, utilized in the transaction, agreement, or contract.

At step 608, the transaction report can be transmitted to the user computer 20 or user communication device 20 associated with the individual or entity. Thereafter, the individual or entity can review the information contained in the transaction report and transmit an appropriate response to the central processing computer 10 to either approve or authorize or to disapprove of or to de-authorize the transaction, the agreement, or the contract. Thereafter, the central processing computer 10 can receive and process the individual's or the entity's response.

If the response contains information for approving or authorizing the transaction, the agreement, or the contract, then the central processing computer will complete or consummate the transaction, the agreement, or the contract. If, however, the response contains information for disapproving or de-authorizing the transaction, the agreement, or the contract, then the central processing computer will cancel the transaction, the agreement, or the contract.

In another preferred embodiment of FIGS. 6A and 6B, at step 611, the central processing computer 10, prior to, during, or subsequent to canceling the transaction, the agreement, or the contract, can generate a transaction report containing any pertinent information regarding the transaction, the agreement, the contract, the subject matter of the respective transaction, agreement, or contract, the parties, counter party, or counter parties, involved in the respective transaction, agreement, or contract, and/or the respective electronic signature(s), electronic initial(s), electronic identification code(s), electronic identification information, and/or electronic identification indicia, utilized in the transaction, agreement, or contract.

At step 611, the transaction report can be transmitted to the user computer 20 or user communication device 20 associated with the individual or entity. Thereafter, the individual or entity can review the information contained in the transaction report and transmit an appropriate response, if desired, to the central processing computer 10. The response can contain other or additional restrictions and/or limitations regarding the respective electronic signature(s), electronic initial(s), electronic identification code(s), and/or other electronic identification indicia.

If the response contains other or additional restrictions and/or limitations regarding the respective electronic signature~s), electronic initial(s), electronic identification code(s), and/or other electronic identification indicia, then the central processing computer 10 will process and store the information regarding the restrictions and/or limitations for processing in a subsequent transaction(s) involving the respective electronic signature(s), electronic initial(s), electronic identification code(s), and/or other electronic identification indicia.

In another preferred embodiment, the individual or entity can access the central processing computer 10 via the user computer 20 and provide information to the central processing computer 10 which information can be utilized for, and/or to facilitate, a pre-authorization for, or a pre-approval of, the use of any one or more of his, her, or its, electronic signature(s) and/or electronic signature information.

The central processing computer 10 can store the pre-authorization information and/or the pre-approval information in the database 10H. Thereafter, the central processing computer 10 can process a transaction, an agreement, or a contract, in which the electronic signature is being utilized, in accordance with, and/or in conjunction with, the individual's or the entity's instructions regarding the pre-authorization and/or the pre-approval, in order to effectuate the consummation or the completion of the respective transaction, agreement, and/or contract, in accordance with the individuals or the entity's instructions or desires.

In other preferred embodiments, the apparatus and method can be utilized in order to provide a multitude of services and/or processing routines for providing information and/or for processing information for providing security for any of the electronic signatures, the electronic initials, the electronic identification code(s), and/or any other electronic identification indicia, described herein.

In another preferred embodiment, the apparatus 100 and method of the present invention can be utilized in order to maintain records of use or usage of any of the herein-described electronic signatures, electronic initials, electronic identification codes, electronic identification information, and/or electronic identification indicia.

The apparatus and method of the present invention and, in particular, each of the central processing computers 10, the user computers 20, and/or the counter party computers 30, can record and store information regarding any and/or all use or usage of any of the electronic signatures, electronic initials, electronic identification codes, electronic identification information, and/or electronic identification indicia, which are used or utilized in conjunction with a transactions, agreements, and/or contracts.

Information and/or details for, or regarding, any of the transaction, agreements, or contracts, can also be recorded and stored along with information regarding the respective electronic signatures, electronic initials, electronic identification codes, electronic identification information, and/or electronic identification indicia, which are utilized in conjunction therewith.

The usage information can contain the respective transaction, agreement, or contract, any details and/or conditions regarding and/or relating to the respective transaction, agreement, or contract, the individual, individuals, entity, entities, parties and/or counter parties involved, in the respective transaction, agreement, or contract, the date(s) and time(s) of the respective transaction, agreement, or contract, the subject matter of or involved in the respective transaction, agreement, or contract, and the respective electronic signatures, electronic initials, electronic identification codes, electronic identification information, and/or electronic identification indicia, which are utilized in the respective transact, agreement, or contract.

The transaction information can also include information regarding the number of times in which the respective electronic signatures, electronic initials, electronic identification codes, electronic identification information, and/or electronic identification indicia, are utilized, the number of times in which the respective electronic signatures, electronic initials, electronic identification codes, electronic identification information, and/or electronic identification indicia, are utilized in conjunction with an individual, an entity, a party, and/or a counter party, the number of times in which a respective electronic signatures, electronic initials, electronic identification codes, electronic identification information, and/or electronic identification indicia, are utilized in conjunction with a particular transaction, agreement, or contract, and/or the conditions under which the respective electronic signatures, electronic initials, electronic identification codes, electronic identification information, and/or electronic identification indicia, were utilized.

The apparatus 100 and/or the central processing computer 10 can count the number of times a respective electronic signature~s), electronic initial(s), electronic identification code(s), electronic identification information, and/or electronic identification indicia, have been used in authorized transactions and can store and/or maintain this information in the database 10H. The apparatus 100 and/or the central processing computer 10 can also count the number of times in which the respective electronic signature(s), electronic initial(s), electronic identification code(s), electronic identification information, and/or electronic identification indicia, have been attempted to be used in unauthorized transactions and can store and/or maintain this information in the database 10H.

The apparatus 100 and/or the central processing computer 10 can also record and/or store any information regarding the use, attempted use, authorized use, approved use, unauthorized use, and/or unapproved use, of any of the respective electronic signature(s), electronic initial(s), electronic identification code(s), electronic identification information, and/or electronic identification indicia, and store and/or maintain records and/or information regarding same in the database 10H of the central processing computer as well as any of the databases 20H and/or 30H of the respective user computers 20 and/or counter party computers 30.

The apparatus 100 and/or the central processing computer 10 can also cancel and/or de-activate the use or usage of an electronic signature(s), electronic initial(s), electronic identification code(s), electronic identification information, and/or electronic identification indicia, upon determining that it has been used, that it is being used, and/or that it has attempted to be used, in an unauthorized manner.

The transaction information can also include the addresses of the respective computers, user computers 20, counter party computers 30, or other computers which are the originators of a respective electronic signatures, electronic initials, electronic identification codes, electronic identification information, and/or electronic identification indicia, and/or the originators of the transmission and/or deployment of any of the respective electronic signatures, electronic initials, electronic identification codes, electronic identification information, and/or electronic identification indicia.

Transaction numbers or transaction identification numbers can be assigned to each of the transactions, agreements, and contracts, with the transaction numbers or transaction identification number associated with and/or corresponding to the particular use or instance of use of each of the respective electronic signatures, electronic initials, electronic identification codes, electronic identification information, and/or electronic identification indicia. The transaction numbers or transaction identification numbers can also be stored in the database 10H of the central processing computer as well as in the respective databases 20H of the user computers 20 and the databases 30H of the counter party computers 30.

The central processing computer 10 can process the above-described transaction information regarding the transactions, agreements, and/or contracts, and any of the above-described information relating to any of the -transactions, agreements, or contracts, and can generate transaction statements regarding the use or usage of the respective electronic signatures, electronic initials, electronic identification codes, electronic identification information, and/or electronic identification indicia.

For example the central processing computer 10 can generate transaction reports detailing the transactions which occur which involve the respective electronic signatures, electronic initials, electronic identification codes, electronic identification information, and/or electronic identification indicia, indicating the data and time of the use or usage of the respective electronic signatures, electronic initials, electronic identification codes, electronic identification information, and/or electronic identification indicia, the individual(s), entity or entities, parties, and/or counter parties involved in the transaction, agreement, and/or contract, the subject matter of the transaction, agreement, and/or contract, and/or any of the other information described herein as being stored and/or processed by the apparatus and method of the present invention.

The transaction reports can be generated periodically and/or ant any time. For example, a individual or entity can receive transaction reports, which can be transmitted to their respective user computers 20 or user communication devices 20 daily, weekly, monthly, quarterly, semi-annually, annually, and/or at any time interval.

An individual can also, at any time, access the central processing computer 10 from his or her user computer 20 or user communication device 20, and request a transaction report. The central processing computer can process the individual's request for the transaction report, generate the transaction report and transmit same to the user computer 20 or the user communication device 20 in real-time and/or at any other time. Thereafter, the individual can review the transaction report, scroll through or scroll down the transaction report, print out the transaction report and/or store the transaction report in the database 20H of the user computer 20 or user communication device 20.

An individual or entity can also, for example, access the central processing computer 10, at any time any request transaction reports which are customized to meet their needs regarding the monitoring of the use or the usage of his, her, or its, respective electronic signature(s), electronic initial(s), electronic identification code(s), electronic identification information, and/or electronic identification indicia. For example, the individual can request to be notified regarding all transactions, agreements, or contracts, for which his or her respective electronic signature(s), electronic initial(s), electronic identification code(s), electronic identification information, and/or electronic identification indicia, have been utilized.

The individual can also request the information regarding the origination or originating addresses, of the respective computers or communication devices, regarding each of the respective electronic signature(s), electronic initial(s), electronic identification code(s), electronic identification information, and/or electronic identification indicia, which are utilized in a transaction, agreement, or contract. The origination information and/or origination address information can be obtained from the respective user computer(s) 20, counter party computer(s) 30, the central processing computer(s) 10, and/or any other computer or communication device which can be the computer or device from which an electronic signature(s), electronic initial(s), electronic identification code(s), electronic identification information, and/or electronic identification indicia, originates and/or is transmitted from.

The origination address can be any unique identifier which is assigned to the respective computer or communication device in the communication network. The individual can also request information regarding the parties or counter parties involved in the transactions, agreements, or contracts.

The individual can request any of the other information described herein as being stored and/or processed by the apparatus 100, the central processing computer(s) 10, and/or any of the user computers 20 and/or counter party computers 30.

The information in the transaction reports which are provided by the apparatus and method of the present invention can be arranged in any appropriate manner. The information in the transaction report can also be sequentially numbered by transaction number.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of any of the respective the user(s), individual(s), entity, entities, party, parties, counter party, and/or counter parties, described herein, so as to act on behalf of the respective party as well as to perform any of processing functions and/or other functions described herein.

The intelligent agent can act on behalf of the respective party in various related interactions and/or other activities which are described as being performed herein and/or which may be incidental and/or related thereto. Therefore, the present invention also provides an agent-based apparatus and method for providing security for electronic signatures.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mail messages, electronic message transmissions, electronic notification transmissions, telephone calls, telephone messages, facsimile transmissions, and/or communications of any kind, which are described herein, between any of the parties which utilize the present invention.

In any and/or all of the embodiments described herein, any electronic messages, such as e-mails, electronic message transmissions, pager messages, telephone calls or messages, facsimile transmissions, etc., which are generated by the central processing computer 10, and/or any of the other computer 20 and/or can contain appropriate links, hyperlinks, and/or forwarding information, to the sending party to another electronic message and/or e-mail, to a third party, to other information, and/or to another information source. In this manner, for example, an e-mail message, transmitted from and/or on behalf of a respective party or counter party can contain a hyperlink(s) to the respective party or counter party and/or the respective counter party computer 30 or counter party communication device 30 associated therewith.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

The data and/or information, described as being stored in the database 10H and/or in any of the other databases described herein, can be continuously updated so as to store the latest values for the data and/or information and can be stored and be made available for future processing routines.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers and/or communication devices 10 and/or 20 and/or external computers or communication devices, described herein, in real-time, and/or via dynamically linked database management techniques. The above-described updates can also be provided from other information sources via the communication network.

The data and/or information which is stored in the database 10H and/or which may be otherwise utilized with, and/or in conjunction with, the apparatus and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

In any and/or all of the embodiments described herein, any interactions, negotiations, and/or deals reached, between any of the individuals, entities, parties, ands/or counter parties, can be monitored and/or can be recorded by the central processing computer 10 and can be stored in the database 10H.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, as well as in, or on any internets and/or intranets, the Internet, the World Wide Web, and any other suitable communication network or system.

In addition to any and/or all of the preferred embodiments described herein, the present invention can also be utilized in other preferred embodiments so as to incorporate, so as to improve upon, and/or so as to utilize, various teachings of the prior art. In this regard, Applicant hereby incorporates by reference herein the subject matter and teachings of the following U.S. Patents: U.S. Pat. No. 6,047,270 which teaches an apparatus and method for providing account security; U.S. Pat. No. 5,903,830 which teaches and discloses a transaction security apparatus and method; U.S. Pat. No. 5,878,337 which teaches and discloses a transaction security apparatus and method; U.S. Pat. No. 5,948,103 which teaches and discloses an electronic document security system, affixed electronic seal security system and electronic signature security system; U.S. Pat. No. 5,915,024 which teaches and discloses an electronic signature addition method, electronic signature verification method, and system and computer program product using these methods; U.S. Pat. No. 5,719,940 which teaches and discloses a method for providing information security by exchanging authentication and signing an electronic signature and apparatus therefor; U.S. Pat. No. 5,689,567 which teaches and discloses an electronic signature method and apparatus; and U.S. Pat. No. 4,326,567 which teaches and discloses a high security system for electronic signature verification.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for providing security for electronic signatures, comprising:
a processor for processing information corresponding to at least one of a transaction, an agreement, and a contract, involving at least one of an electronic signature, an electronic initial, an electronic identification code, electronic identification information, and electronic identification indicia, and further wherein said processor at least one of generates and transmits a transaction report, wherein said transaction report contains information for providing a notification of a use of said at least one of an electronic signature, an electronic initial, an electronic identification code, electronic identification information, and electronic identification indicia; and
a transmitter for transmitting said transaction report to at least one of at least one of an individual and an entity associated with said at least one of an electronic signature, an electronic initial, an electronic identification code, electronic identification information, and electronic identification indicia, and to a communication device associated with the at least one of an individual and an entity associated with said at least one of an electronic signature, an electronic initial, an electronic identification code, electronic identification information, and electronic identification indicia, wherein said transaction report provides notification of the use of said at least one of an electronic signature, an electronic initial, an electronic identification code, electronic identification information, and electronic identification indicia.

2. The apparatus of claim 1, further comprising:
a receiver for at least one of receiving said information corresponding to said at least one of a transaction, an agreement, and a contract, and receiving a response to said transaction report.

3. The apparatus of claim 1, further comprising:
an input device for inputting said information corresponding to said at least one of a transaction, an agreement, and a contract, into said apparatus.

4. The apparatus of claim 1, further comprising:
a communication device associated with the at least one of an individual and an entity associated with said at least one of an electronic signature, an electronic signature, an electronic initial, an electronic identification code, electronic identification information, and electronic identification indicia, wherein said communication device is at least one of a device for receiving said notification signal, a telephone, a third generation (3G) telephone, a video telephone, a videophone, a beeper, a pager, a two-way pager, a reply pager, a home computer, a personal computer, a personal communication device, a personal communication services device, a digital communication device, a television, an interactive television, a digital television, a personal digital assistant, a display telephone, a radio, a car radio, a watch, a cellular telephone, a wireless telephone, a mobile telephone, a display cellular telephone, and a facsimile machine.

5. The apparatus of claim 1, wherein said transaction report contains at least one of information regarding said at least one of an electronic signature, an electronic initial, an electronic identification code, electronic identification information, and electronic identification indicia, involved in said at least one of a transaction, an agreement, and a contract, and information regarding said at least one of a transaction, an agreement, and a contract.

6. The apparatus of claim 1, wherein said processor processes said information corresponding to said at least one of a transaction, an agreement, and a contract, in conjunction with at least one of a restriction on, a limitation on, a pre-authorization of, and a pre-approval of, a use of said at least one of an electronic signature, an electronic initial, an electronic identification code, electronic identification information, and electronic identification indicia.

7. The apparatus of claim 1, wherein said at least one of a transaction, an agreement, and a contract, is at least one of a financial at least one of transaction, agreement, and contract, a commercial at least one of transaction, agreement, and contract, a non-financial at least one of transaction, agreement, and contract, and a non-commercial at least one of transaction, agreement, and contract.

8. The apparatus of claim 1, wherein said Aft processor at least one of counts the number of times in which said at least one of an electronic signature(s), an electronic initial(s), an electronic identification code(s), electronic identification information, and electronic identification indicia, has been used in authorized transactions, counts the number of times in which said at least one of an electronic signature(s), an electronic initial(s), an electronic identification code(s), electronic identification information, and electronic identification indicia, has been attempted to be used in unauthorized transactions, and at least one of cancels and de-activates the use or usage of said at least one of an electronic signature(s), an electronic initial(s), an electronic identification code(s), electronic identification information, and electronic identification indicia.

9. The apparatus of claim 1, wherein said processor at least one of stores information regarding use of said at least one of an electronic signature(s), an electronic initial(s), an electronic identification code(s), electronic identification information, and electronic identification indicia, updates information regarding the use of said at least one of an electronic signature(s), an electronic initial(s), an electronic identification code(s), electronic identification information, and electronic identification indicia, and generates transaction records containing information regarding the use of said at least one of an electronic signature(s), an electronic initial(s), an electronic identification code(s), electronic identification information, and electronic identification indicia, in at least one of a transaction, an agreement, and a contract.

10. The apparatus of claim 1, wherein said processor processes said at least one of a transaction, an agreement, and a contract, in conjunction with at least one of a restriction and a limitation on the use of said at least one of an electronic signature(s), an electronic initial(s), an electronic identification code(s), electronic identification information, and electronic identification indicia, wherein said at least one of a restriction and a limitation is at least one of a restriction and a limitation regarding at least one of at least one of type and kind of at least one of transaction, agreement, and contract, which is authorized, the at least one of type and kind of at least one of transaction, agreement, and contract, which is not authorized, authorized transaction times, unauthorized transaction times, authorized transaction parties, authorized transaction counter parties, unauthorized transaction parties, unauthorized transaction counter parties, authorized transaction at least one of areas, geographic areas, and geographic regions, unauthorized transaction at least one of areas, geographic areas, and geographic regions, authorized transaction amounts, authorized transaction obligations, unauthorized transaction amounts, unauthorized transaction obligations, authorized at least one of goods, products, and services, which can be the subject of at least one of a transaction, an agreement, and a contract, and unauthorized at least one of goods, products, and services, which can be the subject of at least one of a transaction, an agreement, and a contract.

11. A method for providing security for electronic signatures, comprising:
processing information corresponding to at least one of a transaction, an agreement, and a contract, involving at least one of an electronic signature, an electronic initial, an electronic identification code, electronic identification information, and electronic identification indicia;
at least one of generating and transmitting a transaction report, wherein said transaction report contains information for providing a notification of a use of said at least one of an electronic signature, an electronic initial, an electronic identification code, electronic identification information, and electronic identification indicia; and
transmitting said transaction report to at least one of at least one of an individual and an entity associated with said at least one of an electronic signature, an electronic initial, an electronic identification code, electronic identification information, and electronic identification indicia, and to a communication device associated with the at least one of an individual and an entity associated with said at least one of an electronic signature, an electronic initial, an electronic identification code, electronic identification information, and electronic identification indicia, wherein said transaction report provides notification of the use of said at least one of an electronic signature, an electronic initial, an electronic identification code, electronic identification information, and electronic identification indicia.

12. An apparatus for providing security for electronic signatures, comprising:
a receiver for receiving information regarding at least one of a restriction and a limitation on a usage of at least one of an electronic signature, an electronic initial, an electronic identification code, electronic identification information, and electronic identification indicia;
a memory device for storing said information regarding said at least one of a restriction and a limitation on a usage of said at least one of an electronic signature, an electronic initial, an electronic identification code, electronic identification information, and electronic identification indicia; and
a processor for processing information regarding at least one of a transaction, an agreement, and a contract, involving said at least one of electronic signature, an electronic initial, an electronic identification code, electronic identification information, and electronic identification indicia, in conjunction with said information regarding at least one of a restriction and a limitation on a usage of said at least one of an electronic signature, an electronic initial, an electronic identification code, electronic identification information, and electronic identification indicia,
wherein said processor generates a transaction report, and further wherein said transaction report contains information for one of approving and disapproving the use of said at least one of an electronic signature, an electronic initial, an electronic identification code, electronic identification information, and electronic identification indicia.

13. The apparatus of claim 12, wherein said processor generates a notification report containing information regarding the use of said at least one of an electronic signature, an electronic initial, an electronic identification code, electronic identification information, and electronic identification indicia, in said at least one of a transaction, an agreement, and a contract.

14. The apparatus of claim 13, further comprising:
a transmitter for transmitting said notification report to a communication device associated with the at least one of an individual and an entity associated with said at least one of an electronic signature, an electronic initial, an electronic identification code, electronic identification information, and electronic identification indicia.

15. The apparatus of claim 14, wherein the communication device is one of a device for receiving said notification signal, a telephone, a third generation (3G) telephone, a video telephone, a videophone, a beeper, a pager, a two-way pager, a reply pager, a home computer, a personal computer, a personal communication device, a personal communication services device, a digital communication device, a television, an interactive television, a digital television, a personal digital assistant, a display telephone, a radio, a car radio, a watch, a cellular telephone, a wireless telephone, a mobile telephone, a display cellular telephone, and a facsimile machine.

16. The apparatus of claim 12, wherein said one of a restriction and a limitation are received in real-time.

17. The apparatus of claim 12, wherein said at least one of a transaction, an agreement, and a contract, is at least one of a financial at least one of transaction, agreement, and contract, a commercial at least one of transaction, agreement, and contract, a non-financial at least one of transaction, agreement, and contract, and a non-commercial at least one of transaction, agreement, and contract.

18. The apparatus of claim 12, wherein said processor at least one of counts the number of times in which said at least one of an electronic signature(s), an electronic initial(s), an electronic identification code(s), electronic identification information, and electronic identification indicia, has been used in authorized transactions, counts the number of times in which said at least one of an electronic signature(s), an electronic initial(s), an electronic identification code(s), electronic identification information, and electronic identification indicia, has been attempted to be used in unauthorized transactions, and at least one of cancels and de-activates the use or usage of said at least one of an electronic signature(s), an electronic initial(s), an electronic identification code(s), electronic identification information, and electronic identification indicia.

19. The apparatus of claim 12, wherein said processor at least one of stores information regarding use of said at least one of an electronic signature(s), an electronic initial(s), an electronic identification code(s), electronic identification information, and electronic identification indicia, updates information regarding use of said at least one of an electronic signature(s), an electronic initial(s), an electronic identification code(s), electronic identification information, and electronic identification indicia, and generates transaction records containing information regarding use of said at least one of an electronic signature(s), an electronic initial(s), an electronic identification code(s), electronic identification information, and electronic identification indicia, in said at least one of a transaction, an agreement, and a contract.

20. The apparatus of claim 12, wherein said processor processes said at least one of a transaction, an agreement, and a contract, in conjunction with at least one of a restriction and a limitation on the use of said at least one of an electronic signature(s), an electronic initial(s), an electronic identification code(s), electronic identification information, and electronic identification indicia, wherein said at least one of a restriction and a limitation is at least one of a restriction and a limitation regarding at least one of at least one of type and kind of at least one of transaction, agreement, and contract, which is authorized, the at least one of type and kind of at least one of transaction, agreement, and contract, which is not authorized, authorized transaction times, unauthorized transaction times, authorized transaction parties, authorized transaction counter parties, unauthorized transaction parties, unauthorized transaction counter parties, authorized transaction at least one of areas, geographic areas, and geographic regions, unauthorized transaction at least one of areas, geographic areas, and geographic regions, authorized transaction amounts, authorized transaction obligations, unauthorized transaction amounts, unauthorized transaction obligations, authorized at least one of goods, products, and services, which can be the subject of at least one of a transaction, an agreement, and a contract, and unauthorized at least one of goods, products, and services, which can be the subject of at least one of a transaction, an agreement, and a contract.
